(19) United States
(12) Patent Application Publication
(10) Pub. No.: US 2025/0018294 A1
(43) Pub. Date: Jan. 16, 2025

(54) METHOD AND APPARATUS FOR DISPLAYING INFORMATION OF VIRTUAL OBJECT, ELECTRONIC DEVICE, AND STORAGE MEDIUM

(71) Applicant: NETEASE (HANGZHOU) NETWORK CO., LTD., Hangzhou, Zhejiang (CN)

(72) Inventors: Guang LI, Hangzhou, Zhejiang (CN); Chao LIU, Hangzhou, Zhejiang (CN); Xiangyu WANG, Hangzhou, Zhejiang (CN)

(73) Assignee: NETEASE (HANGZHOU) NETWORK CO., LTD., Hangzhou, Zhejiang (CN)

(21) Appl. No.: 18/556,115

(22) PCT Filed: Feb. 23, 2022
(86) PCT No.: PCT/CN2022/077514

§ 371 Date: Oct. 19, 2023

(30) Foreign Application Priority Data
Apr. 19, 2021 (CN) 202110420287.3

(51) Int. Cl. A63F 13/5375; A63F 13/52; A63F 13/5372; A63F 13/5378; A63F 13/55

(52) U.S. Cl. CPC A63F 13/5375; A63F 13/52; A63F 13/5372; A63F 13/5378; A63F 13/55

(57) ABSTRACT

Provided are a method and an apparatus for displaying information of a virtual object, an electronic device, and a storage medium, the method including: displaying in a graphical user interface a first virtual scene and a first virtual object located in the first virtual scene; in response to a motion operation for the first virtual object, controlling the first virtual object to move in the first virtual scene, and controlling the range of the first virtual scene displayed in the graphical user interface to change correspondingly on the basis of the motion of the first virtual object; in response to a note adding operation, displaying in the graphical user interface note prompting information of at least one second virtual object; and, in response to a trigger operation for the note prompting information, adding note information to a target virtual object amongst the displayed at least one second virtual object.

### CROSS REFERENCE TO RELATED APPLICATIONS

The present application is the 371 application of PCT Application No. PCT/CN2022/077514, filed on Feb. 23, 2022, which is based upon and claims the priority to the Chinese Patent Application NO. 202110420287.3, entitled “METHOD AND APPARATUS FOR DISPLAYING INFORMATION OF VIRTUAL OBJECT, ELECTRONIC DEVICE, AND STORAGE MEDIUM”, filed on Apr. 19, 2021, the entire contents of both of which are hereby incorporated by reference.

### TECHNICAL FIELD

The present disclosure relates to the field of human-computer interaction technologies, and in particular, to a method and apparatus for displaying information of a virtual object, an electronic device, and a storage medium.

### BACKGROUND

With the continuous development of the game industry, game types are constantly expanding, where reasoning games are loved by the majority of players for their unique charm. This type of game requires a plurality of players to participate in the interaction, and players from different camps make inference and conduct voting while completing specified tasks.

During the game, it is necessary to analyze identity information of other players based on their behavior information and the like to avoid players with suspicious identities during actions.

### SUMMARY

In a first aspect, embodiments of the present disclosure provide a method for displaying information of a virtual object, wherein a graphical user interface is provided by a terminal device. The method includes:
displaying in the graphical user interface a first virtual scene and a first virtual object located in the first virtual scene;
in response to a movement operation for the first virtual object, controlling the first virtual object to move in the first virtual scene, and controlling, according to movement of the first virtual object, a first virtual scene range displayed in the graphical user interface to change accordingly;
displaying in the graphical user interface note prompt information of at least one second virtual object in response to a note addition operation; and
adding note information to a target virtual object among the at least one second virtual object displayed in response to a trigger operation for the note prompt information.

In a second aspect, embodiments of the present disclosure further provide an electronic device, including: a processor, a storage medium, and a bus, wherein machine-readable instructions executable by the processor are stored in the storage medium, and when the electronic device is running, the processor is in communication with the storage medium through the bus, and the processor executes the machine-readable instructions to execute steps of the method for displaying the information of the virtual object as described above.

In order to make the objectives, features and advantages of the present disclosure more apparent and understandable, preferred embodiments are exemplified below and described in detail with reference to the accompanying drawings.

### BRIEF DESCRIPTION OF THE DRAWINGS

In order to explain technical solutions in embodiments of the present disclosure more clearly, drawings needed in these embodiments will be briefly introduced below. It should be understood that the following drawings only show some embodiments of the present disclosure, and should not be regarded as a limitation of the scope. For those of ordinary skill in the art, other relevant drawings may be obtained from these drawings without creative labor.

FIG. 1 is a flowchart of a method for displaying information of a virtual object provided by an embodiment of the present disclosure;

FIG. 2 is a schematic diagram of an interface in which a note list is displayed in a first virtual scene provided by an embodiment of the present disclosure;

FIG. 3 is schematic diagram of an interface in which an identity voting control is displayed in a second virtual scene provided by an embodiment of the present disclosure;

FIG. 4 is a schematic diagram of an interface in which identity information is displayed in a second virtual scene provided by an embodiment of the present disclosure;

FIG. 5 is a schematic diagram of an interface in which a second virtual object with the added note information is included in a second virtual scene provided by an embodiment of the present disclosure;

FIG. 6 is a schematic diagram of an interface in which note information is added to a virtual object through a screenshot image provided by an embodiment of the present disclosure;

FIG. 7 is a schematic diagram of a screenshot image after note information is added to a virtual object provided by an embodiment of the present disclosure;

FIG. 8 is a first interface schematic diagram of a first virtual scene provided by an embodiment of the present disclosure;

FIG. 9 is a first interface schematic diagram of a second virtual scene provided by an embodiment of the present disclosure;

FIG. 10 is a second interface schematic diagram of a first virtual scene provided by an embodiment of the present disclosure;

FIG. 11 is a third interface schematic diagram of a first virtual scene provided by an embodiment of the present disclosure;

FIG. 12 is a second interface schematic diagram of a second virtual scene provided by an embodiment of the present disclosure;

FIG. 13 is a schematic diagram of movement of a virtual object provided by an embodiment of the present disclosure;

FIG. 14 is a schematic structural diagram of an apparatus for displaying information of a virtual object provided by an embodiment of the present disclosure; and

FIG. 15 is a schematic structural diagram of an electronic device provided by an embodiment of the present disclosure.

### DETAILED DESCRIPTION

In order to make objectives, technical solutions and advantages of embodiments of the present disclosure clearer, the technical solutions will be described below in a clear and complete manner in conjunction with the accompanying drawings in the embodiments of the present disclosure. It is apparent that the described embodiments are only a part of the embodiments of the present disclosure, and not all of the embodiments. The components of embodiments of the present disclosure generally described and illustrated in the accompanying drawings herein may be arranged and designed in a variety of different configurations. Accordingly, the following detailed description of embodiments of the present disclosure provided in the accompanying drawings is not intended to limit the scope of the present disclosure for which protection is claimed, but rather represents only selected embodiments of the present disclosure. Based on the embodiments of the present disclosure, each other embodiment obtained by a person skilled in the art without creative labor are within the scope of protection of the present disclosure.

First, a brief introduction is given to names involved in embodiments of the present disclosure.

Virtual scene: it is a virtual scene displayed (or provided) when an application is running on a terminal or server. In some embodiments of the present disclosure, the virtual scene is a simulation environment for the real world, or a semi-simulated and semi-fictional virtual environment, or a pure fictional virtual environment. The virtual scene is any one of two-dimensional virtual scene and three-dimensional virtual scene. The virtual environment can be the sky, land, sea, etc., where the land includes deserts, cities and other environmental elements. The virtual scene is a scene of a complete game logic of a virtual object controlled by the user.

Virtual object: it refers to a dynamic object that can be controlled in the virtual scene. In some embodiments of the present disclosure, the dynamic object may be a virtual character, a virtual animal, an animated character, and so on. The virtual object is a character controlled by a game player through an input device, or an artificial intelligence (AI) that has been trained to battle in a virtual environment, or a non-player character (NPC) that has been set up to battle in a virtual scene. In some embodiments of the present disclosure, the virtual object is a virtual character competing in a virtual scene. In some embodiments of the present disclosure, the number of virtual objects in the battle of the virtual scene may be preset or may be dynamically determined according to the number of clients participating in the battle, which is not limited by embodiments of the present disclosure. In an implementation of the present disclosure, the user may control the movement of the virtual object in the virtual scene, such as running, jumping, crawling, etc., and may also control the virtual object to use a skill, a virtual prop, etc., provided by the application to fight with other virtual objects.

Player character: it refers to a virtual object that can be controlled by the game player to move around in the game environment. In some video games, it may also be called a god character (or Shikigami character) or hero character. The player character may be at least one of the different forms such as a virtual character, a virtual animal, an animated character, a virtual vehicle, etc.

Game interface: it refers to an interface corresponding to an application provided or displayed through a graphical user interface, which includes a game screen and an UI interface for interaction between game players. In an embodiment of the present disclosure, the UI interface may include game controls (e.g., skill controls, movement controls, function controls, etc.), indication identifiers (e.g., direction indication identifiers, character indication identifiers, etc.), information display areas (e.g., the number of kills, a competition time, etc.), or game setting controls (e.g., system settings, stores, coins, etc.). In an embodiment of the present disclosure, the game screen is a display screen corresponding to the virtual scene displayed by the terminal device, and the game screen may include virtual objects such as game characters, NPC characters, Al characters, and so on, which perform the game logic in the virtual scene.

A method for displaying information of a virtual object in an embodiment of the present disclosure may run on a local terminal device or a server. When the method for displaying the information of the virtual object runs on the server, the method may be realized and executed based on a cloud interaction system, and the cloud interaction system includes a server and a client device.

In an embodiment of the present disclosure, various cloud applications, such as cloud gaming, can be run under the cloud interaction system. Taking the cloud gaming as an example, the cloud gaming refers to a game mode based on cloud computing. In the running mode of the cloud gaming, a main body of running the game program and a main body of presenting the game screen are separated, and the storage and running of a method for processing information are completed on the cloud game server, while a function of the client device is to receive and send data and present the game screen. For example, the client device may be a display device with data transmission function close to the user side, such as a mobile terminal, TV, computer, personal digital assistant (PDA), etc., but the information processing is carried out by the cloud game server in the cloud. When playing the game, the game player operates the client device to send operation instructions to the cloud game server, and the cloud game server runs the game according to the operation instructions, encodes and compresses the game screen and other data, and returns them to the client device through the network, and finally the client device decodes and outputs the game screen.

In an embodiment of the present disclosure, taking a game as an example, a local terminal device stores a game program and is configured to present a game screen. The local terminal device is configured to interact with the game player via a graphical user interface, i.e., the game program is routinely downloaded, installed, and run via an electronic device. The local terminal device provides the graphical user interface to the game player in a variety of ways, e.g., the graphical user interface may be rendered and displayed on a display screen of the terminal, or may be provided to the game player via holographic projection. For example, the local terminal device may include a display screen and a processor. The display screen is configured to present the graphical user interface that includes the game screen, and the processor is configured to run the game, generate the graphical user interface, and control the display of the graphical user interface on the display screen.

With the continuous development of the game industry, game types are constantly expanding, where reasoning games are loved by increasingly players for their unique charm. In a reasoning game, a plurality of game players participating in the game join the same game match, and after the players enter the game match, different character attributes, e.g., identity attributes, are assigned to virtual objects controlled by the different game players, so that different camps can be determined through the different character attributes assigned, and the game players can win the game by performing the tasks assigned by the game during the different game stages of the game match. For example, multiple virtual objects with character attribute A can win a game by “eliminating” virtual objects with character attribute B during the game stages. Taking a game as an example, it typically involves 10 persons playing in the same game match, and at the beginning of the game match, the identities (character attributes) of the virtual objects in the game match are determined, including, for example, civilian and werewolf identities. The virtual objects with civilian identities win the game by completing the assigned tasks during the game stages or by eliminating virtual objects with werewolf identities in the current game match. The virtual objects with the werewolf identities win the game by eliminating other virtual objects that are not werewolves by performing attack behaviors on these virtual objects during the game stages.

For the game stages of the reasoning game, there are typically two game stages: an action stage and a discussion stage.

In the action stage, one or more game tasks are usually assigned. In an embodiment of the present disclosure, one or more game tasks are assigned to each virtual object, and the game player completes the game match by controlling the corresponding virtual object to move in the game scene and perform the corresponding game tasks. In an embodiment of the present disclosure, a common game task can be determined for virtual objects with the same character attribute in the current game match. In the action stage, the virtual objects participating in the current game match can move freely to different areas in the game scene of the action stage to complete the assigned game task. The virtual objects in the current game match include a virtual object with a first character attribute and a virtual object with a second character attribute. In an embodiment of the present disclosure, when the virtual object with the second character attribute moves to a preset range of the virtual object with the first character attribute in the virtual scene, the virtual object with the second character attribute may respond to an attack instruction and attack the virtual object with the first character attribute to eliminate the virtual object with the first character attribute.

The discussion stage provides a discussion function for the virtual object representing the game player, through which the behavior of the virtual object during the action stage is presented to determine whether or not to eliminate a specific virtual object in the current game match.

Taking a game as an example, the game match consists of two stages, namely the action stage and the discussion stage. In the action stage, multiple virtual objects in the game match move freely in the virtual scene, and other virtual objects appearing in a preset range can be seen on the game screen presented from one virtual object's viewpoint. The virtual object with the civilian identity completes the assigned game task by moving in the virtual scene. The virtual object with the werewolf identity damages the completed task of the virtual object with the civilian identity in the virtual scene, or may perform a specific assigned game task. In addition, the virtual object with the werewolf identity may also attack the virtual object with the civilian identity during the action stage to eliminate the virtual object with the civilian identity. When the game match enters the discussion stage from the action stage, the game players participate in the discussion through the corresponding virtual objects in an attempt to determine the virtual object with the werewolf identity based on the game behaviors in the action stage, and determine the result of the discussion by voting, and determine whether there is a virtual object that needs to be eliminated according to the result of the discussion, and if so, the corresponding virtual object will be eliminated according to the result of the discussion. If not, there is no virtual object that will be eliminated in the current discussion stage. In the discussion stage, the discussion can be conducted by voice, text, or other means. During the game, it is necessary to analyze identity information of other players based on their behavior information (which may further include text information and voice information input by other players), etc., in order to avoid players with suspicious identities during the game, thereby preventing being attacked and eliminated by the players with the suspicious identities. However, due to the large number of players participating, it is difficult to remember the behavior information of all players to make inferences about the identity information of the players based on the behavior information of the players. In addition, even identity information of some players has been reasoned, it is also difficult to remember the reasoned identity information corresponding to these players during the game, which may easily lead to lower game efficiency for players.

In view of this, embodiments of the present disclosure provide a method for displaying information of a virtual object. Note information is added to a virtual object in a game for each player, so that it is easy for a current player to record behavior information and/or identity information of respective players that have been reasoned during the game. In addition, a note addition operation is relatively convenient, which can improve the game efficiency of the player, while preventing the player from forgetting identity information corresponding to other players that have been reasoned.

An implementation environment is provided in an embodiment of the present disclosure. The implementation environment may include: a first terminal device, a game server, and a second terminal device. The first terminal device and the second terminal device communicate with the server respectively to implement data communication. In this implementation, the first terminal device and the second terminal device are each installed with a client that executes the method for displaying the information of the virtual object provided by the present disclosure, and the game server is a server that executes the method for displaying the information of the virtual object provided by the present disclosure. Through the client, the first terminal device and the second terminal device may respectively communicate with the game server.

Taking the first terminal device as an example, the first terminal device establishes communication with the game server by running the client. In an implementation of the present disclosure, the server establishes a game match according to a game request of the client. A parameter of the game match may be determined based on a parameter in the received game request. For example, the parameter of the game match may include the number of persons participating in the game match, a level of a character participating in the game match, etc. When the first terminal device receives a response from the server, a virtual scene corresponding to the game match is displayed through a graphical user interface of the first terminal device. In an implementation of the present disclosure, the server determines, based on the game request of the client, a target game match for the client from a plurality of game matches that have been established. When the first terminal device receives the response from the server, the virtual scene corresponding to the game match is displayed through the graphical user interface of the first terminal device. The first terminal device is a device controlled by a first user. A virtual object displayed in the graphical user interface of the first terminal device is a player character controlled by the first user. The first user inputs an operation instruction through the graphical user interface to control the player character to perform a corresponding operation in the virtual scene.

Taking the second terminal device as an example, the second terminal device establishes communication with the game server by running the client. In an implementation of the present disclosure, the server establishes a game match according to a game request of the client. A parameter of the game match may be determined based on a parameter in the received game request. For example, the parameter of the game match may include the number of persons participating in the game match, a level of a character participating in the game match, etc. When the second terminal device receives a response from the server, a virtual scene corresponding to the game match is displayed through a graphical user interface of the second terminal device. In an implementation of the present disclosure, the server determines, based on the game request of the client, a target game match for the client from a plurality of game matches that have been established. When the second terminal device receives the response from the server, the virtual scene corresponding to the game match is displayed through the graphical user interface of the second terminal device. The second terminal device is a device controlled by a second user. A virtual object displayed in the graphical user interface of the second terminal device is a player character controlled by the second user. The second user inputs an operation instruction through the graphical user interface to control the player character to perform a corresponding operation in the virtual scene.

The server performs data calculation based on the received game data reported by the first terminal device and the second terminal device, and synchronizes the calculated game data to the first terminal device and the second terminal device, so that the first terminal device and the second terminal device control the rendering of the corresponding virtual scenes and/or virtual objects in the graphical user interfaces according to the synchronization data sent by the server.

In an embodiment of the present disclosure, the virtual object controlled by the first terminal device and the virtual object controlled by the second terminal device are virtual objects in the same game match. The virtual object controlled by the first terminal device and the virtual object controlled by the second terminal device may have the same character attributes, or may have different character attributes.

It should be noted that the virtual objects in the current game match may include two or more virtual objects, and different virtual objects may correspond to different terminal devices, respectively. That is to say; there are more than two terminal devices in the current game match that respectively send and synchronize the game data with the game server.

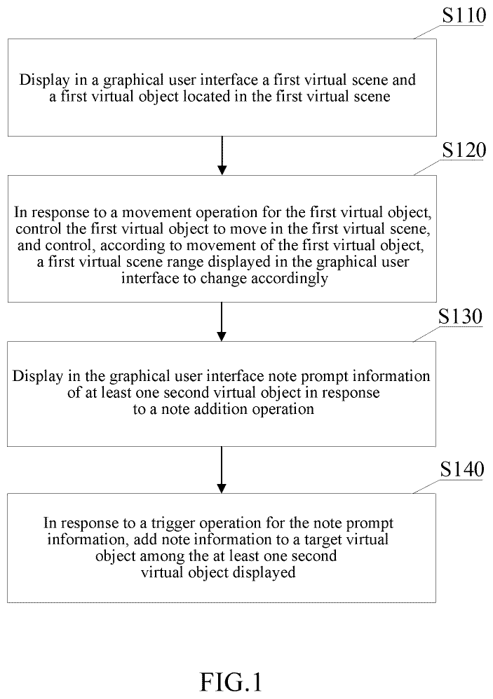

Reference is made to FIG. 1, which is a flowchart of a method for displaying information of a virtual object provided by an embodiment of the present disclosure. As shown in FIG. 1, a graphical user interface is provided by a terminal device in the embodiment of the present disclosure. The terminal device may be the local terminal device or the client device in the cloud gaming system, as described above. The method for displaying the information of the virtual object includes S110 to S140.

In the S110, a first virtual scene and a first virtual object located in the first virtual scene are displayed in the graphical user interface.

In the S120, in response to a movement operation for the first virtual object, the first virtual object is controlled to move in the first virtual scene, and a first virtual scene range displayed in the graphical user interface is controlled, according to movement of the first virtual object, to change accordingly.

In the S130, in response to a note addition operation, note prompt information of at least one second virtual object is displayed in the graphical user interface.

In the S140, in response to a trigger operation for the note prompt information, note information is added to a target virtual object among the at least one second virtual object displayed.

The terminal device involved in embodiments of the present disclosure mainly refers to a smart device configured to provide the graphical user interface and perform a control operation on the virtual object. The terminal device may include but is not limited to any one of the following devices: a smart phone, a tablet computer, a portable computer, a desktop computer, a digital TV and a game console, etc. An application that supports the game, such as an application that supports a three-dimensional or two-dimensional game, is installed and run on the terminal device. In embodiments of the present disclosure, the application as a game application is taken as example for illustration. In some embodiments of the present disclosure, the application may be a network online game application or a stand-alone game application.

The graphical user interface is an interface display format for human-computer communication that allows a user to use an input device, such as a mouse, a keyboard, and a game pad, to manipulate an icon or a menu option on the screen, and also allows the user to manipulate the icon or the menu option on the screen by performing a touch operation on the touch screen of the terminal device, to select a command, initiate a program, perform some other tasks, or the like.

In addition to the movable virtual object mentioned above, the virtual scene may also include other immovable virtual objects, such as, but is not limited to, the sky; land, ocean, buildings, mountains, forests, mission props, etc. As an example, the virtual object, a map, a room, the building, etc. are typically included in the common reasoning game.

The above illustrative respective steps provided by embodiments of the present disclosure will be described below, respectively, by taking the method being applied to the terminal device as an example.

In the step S110, in response to an opening operation of a game player, a game client on the terminal device displays the first virtual scene and the first virtual object located in the first virtual scene in the graphical user interface. The opening operation may include an operation of clicking the application through the mouse on the computer, or an operation of clicking or sliding the game application (APP) through the touch screen on the mobile terminal.

In embodiments of the present disclosure, the first virtual scene may include the above-mentioned virtual scene corresponding to the action stage of the reasoning game, and virtual objects controlled by respective players may move in the first virtual scene during the action stage. For example, the activity of the virtual object in the first virtual scene may include but is not limited to at least one of: walking, running, jumping, climbing, lying down, attacking, releasing a skill, picking up a prop, and sending a message. Here, in addition to the virtual objects controlled by the respective players, the virtual objects moveable in the first virtual scene may further include other virtual objects not controlled by the player.

The first virtual object is a virtual object in the game of an account logging in the game client on the terminal device, that is, a virtual object controlled by a player corresponding to the account. However, it is not excluded a possibility that the first virtual object is controlled by another application or an artificial intelligence module.

In the step S120, in response to the movement operation by the game player for the first virtual object, the first virtual object is controlled to move in the first virtual scene, and the first virtual scene range displayed in the graphical user interface is controlled, according to the movement of the first virtual object, to change accordingly.

The movement operation in embodiments of the present disclosure is sent by the game player to the terminal device, and the movement operation is used to control the first virtual object to move in the first virtual scene of the graphical user interface. In response to the movement operation, the terminal device may control the first virtual object to move in the first virtual scene. As the first virtual object moves, a position of the first virtual object in the first virtual scene will change accordingly, that is, in response to the movement operation, the terminal device may further control, according to the movement of the first virtual object, the first virtual scene range displayed in the graphical user interface to change accordingly.

For example, a game picture displayed in the graphical user interface may be a picture obtained by observing the first virtual scene with the first virtual object as an observation center. When the first virtual object in the first virtual scene is manipulated to move, the game picture will follow the movement, that is, the observation center of the game picture is bound to the position of the first virtual object, so that the observation center moves as the position of the first virtual object moves. However, the present disclosure is not limited to this, and another observation position in the virtual scene may also be used as the observation center, as long as the first virtual object is included in the displayed first virtual scene, and the displayed first virtual scene range changes accordingly based on the movement of the first virtual object.

For example, the process of controlling the first virtual object to move in the first virtual scene may include: receiving a selection operation by the game player for the first virtual object, and controlling the first virtual object to move in the first virtual scene in response to a drag operation for the selected first virtual object. Alternatively, the process of controlling the first virtual object to move in the first virtual scene may include: receiving a selection operation by the game player for the first virtual object, and in response to a position selection operation performed in the first virtual scene, controlling the first virtual object to move to the selected position. As an example, the movement operation may include but is not limited to: clicking on the first virtual object with the left button of the mouse without releasing it on the computer, and dragging the mouse to change the position of the first virtual object in the first virtual scene; or pressing and holding the first virtual object with the finger without releasing it on the mobile terminal, and changing the position of the first virtual object in the first virtual scene by sliding on the graphical user interface through the finger.

Furthermore, as the first virtual scene range accordingly changes according to the movement of the first virtual object, the changed first virtual scene may include the second virtual object (here, the first virtual scene before the change may also include the second virtual object), where the second virtual object is a virtual object controlled by another player in the current game match. Likewise, the terminal device of the other player may also control the second virtual object to move in the first virtual scene in response to the movement operation of the other player. As the second virtual object moves, a position of the second virtual object in the first virtual scene will also change accordingly.

For example, the first virtual object may perform a task specified by the system in the action stage to achieve a goal of completing the task and winning, and the same is true for the second virtual object in the action stage. If the first virtual object is a virtual object with a first character attribute and the second virtual object is a virtual object with a second character attribute, then during the process of the second virtual object performing the task, the first virtual object may make a trouble for the second virtual object when the second virtual object performs the task, or the first virtual object may kill and eliminate the second virtual object, or the first virtual object may complete the task specified for the first virtual object. If the first virtual object is a virtual object with the second character attribute, and the second virtual object is a virtual object with the first character attribute, the same process as above may be performed. If the first virtual object and the second virtual object have the same character attribute, the first virtual object and the second virtual object may perform the task together or separately, or jointly or separately find another virtual object with another character attribute to interfere with the task execution of the other virtual object and kill the other virtual object

In the step S130, in response to the note addition operation performed by the game player, the note prompt information of the at least one second virtual object is displayed in the graphical user interface to prompt the game player to add the corresponding note information for the at least one second virtual object.

Here, the note addition operation is sent by the game player to the terminal device, and the note addition operation is used to display in the graphical user interface the note prompt information of the at least one second virtual object. The note addition operation may be clicking on a icon, control, button or block on the graphical user interface representing adding a note, a drag operation for the icon or control representing adding the note performed on the graphical user interface, or clicking on a character avatar or a character model of the second virtual object, or a screenshot operation performed on the graphical user interface.

Specifically; in response to a click operation by the game player for the icon, control, button or block representing adding the note, the note prompt information of the at least one second virtual object is displayed in the graphical user interface. Alternatively, in response to a drag operation by the game player for the icon or control representing adding the note, the note prompt information of the at least one second virtual object is displayed in the graphical user interface. Alternatively, in response to a click operation for the model of the second virtual object, the note prompt information of the at least one second virtual object is displayed in the graphical user interface. Alternatively, in response to a screenshot operation performed on the graphical user interface, the note prompt information of the at least one second virtual object is displayed in the graphical user interface.

Here, the note prompt information refers to prompt information that prompts the game player to make notes for the second virtual object. A display form of the note prompt information may include the following four cases.

In a first case, the display form of the note prompt information may be a note list. For example, the note list includes a character name corresponding to the second virtual object, and an identity information option that can represent identity information of the second virtual object. The identity information options may correspond to different character attributes of the virtual object. For example, each identity information option may correspond to an identity attribute. A check box is provided at a position near the identity information option, and the check box is used to respond to a check operation upon the selection of the identity information. Through the note list, the game player can intuitively see the note information that can be added to the second virtual object, that is, the game player can directly select the corresponding identity information from the identity information options in the note list based on the reasoned result, and the identity information is the note information.

In a second case, the display form of the note prompt information may be a note control. The note control may be displayed around the second virtual object, or may also follow the movement of the second virtual object. There is a mark on the note control to remind the game player that this note control is used to display the note prompt information. For example, a control with “label”, “comment” or “mark” is used to represent the note prompt information. When the game player corresponding to the first virtual object wants to add note information to the second virtual object, the game player may click on the note control and then add the note information to the second virtual object. For example, in response to the trigger operation on the note control, a plurality of identity options are displayed on the graphical user interface, each identity option corresponding to a character attribute, and in response to a selection operation on one of the plurality of identity options, the second virtual object is marked with a character attribute corresponding to the selected identity option.

In a third case, the display form of the note prompt information may also be an input box. Some identity information may be preset in the input box with reference to the note list. In addition, the input box may also be a blank input box, which can respond to a content filling operation performed by the game player in the input box, or can also respond to the drag operation of the game player. The input box may be provided at a corner position of the graphical user interface. During the action stage, the game player corresponding to the first virtual object can enter the note information marked for a certain second virtual object in the input box at any time. For the content input in the input box, there is no specific limitation.

In a fourth case, the display form of the note prompt information may also be a plurality of static screenshots. Every time a screenshot is obtained, the identity information option or the input box will automatically be displayed on the graphical user interface. The identity information options may include different character attributes of the virtual object, and the input box can respond to the content input operation of the game player.

It should be understood that the note prompt information as the identity information is taken as an example for illustration in the above examples. However, the present disclosure is not limited thereto, and the note prompt information may also be other description information for the virtual object such as the behavior information.

In addition, the identity information listed in the control or options includes an identity in the game of a virtual object set by the game server for the current game. The control or options may include all identities set by the game server for the player to select.

In addition, it should be understood that when the virtual object controlled by each player enters the current game, the game server will randomly assign an identity to each player. In embodiments of the present disclosure, the note information added to the virtual object refers to information obtained by the player controlling the first virtual object reasoning about a virtual object controlled by another player, that is, the note information added to the virtual object will not change the identity of each player randomly assigned by the game server when each player initially enters the game. The added note information is only visible to the player who controls the first virtual object and is used to help the player remember the reasoning processes with respect to other players during the game.

In the step S140, in response to the trigger operation for the note prompt information, the note information is added to the target virtual object among the at least one displayed second virtual object.

For example, the target virtual object is a virtual object with suspicious identity information determined by the game player corresponding to the first virtual object based on the behavior information of each second virtual object in the action stage. For example, the target virtual object may refer to a virtual object inferred by the game player that may have a target character attribute.

The note information may be the identity information that the second virtual object may have, or the behavior information of the second virtual object, such as appearing at a position near a killed virtual object, a suspicious behavior such as interfering with the task execution of other game players. The note information may be determined in advance based on the players' common words in the game, so that the game player may directly make a selection. In addition, the note information may also be determined through the game player's custom input.

Here, the trigger operation is sent by the game player to the terminal device, and the trigger operation is used to add the note information to the target virtual object among the at least one displayed second virtual object. The trigger operation may include the click operation, the check operation, or the drag operation.

Specifically, when the note prompt information is the note list, in response to the check operation for the check box corresponding to the identity information option in the note list, it is determined to add the note information to the target virtual object. When the note prompt information is the note control, in response to the click operation on the note control, it is determined to add the note information to the target virtual object, or in response to the drag operation on the note control (such as dragging the note control to a position where the target virtual object is located), the note information is added to the target virtual object. When the note prompt information is the input box, in response to the drag operation on the input box, it is determined to drag the input box around the target virtual object, where the input box has responded to the content filling operation of the game player before being dragged or the input box has already contained the note information in advance; alternatively, in response to a selection operation for a content confirmation option, information in the input box is determined as the note information added to the target virtual object. When the note prompt information is a static screenshot, in response to the drag operation for the identity information option (which may also be the note control), the identity information option is dragged to the target virtual object on the screenshot, and it is determined to add the note information to the target virtual object, where the identity information of the second virtual object may be reasoned based on the behavior information of the second virtual object in the action stage.

In the method for displaying the information of the virtual object provided by embodiments of the present disclosure, the note information is added to the virtual object of the other player in the game, so that it is easy for the player to record the identity information of the other player that has been inferred during the game, and the note addition operation is relatively convenient, which can prevent the player from forgetting the identity information corresponding to the other player that has been inferred. In addition, a player with a suspicious identity is determined based on the identity information of the player that has been inferred, so that the player can avoid the player with the suspicious identity when taking action. In this way, the gaming efficiency of the player can be improved.

In embodiments of the present disclosure, the step S130 includes:

in response to the note addition operation, displaying a note list in the graphical user interface, and displaying the note prompt information of the at least one second virtual object in the note list.

Here, the note list refers to a list formed by arranging individual virtual objects in a specified order, and the list includes the note prompt information for the second virtual object. For example, the arrangement may be performed according to the number of strokes of the first Chinese character in the character name (which may also be a nickname) corresponding to the second virtual object from low to high (which may also be from high to low); alternatively, the arrangement may be performed according to the pinyin initial of the first Chinese character in the character name corresponding to the second virtual object from front to back, etc. Specifically, for each second virtual object, the identity information option, the check box corresponding to the identity information option and the character name corresponding to the second virtual object are integrated into a sub-set, and the sub-sets of all the second virtual objects are arranged according to the specified order, so as to obtain the note list. That is to say, the note list may include a plurality of character entries, and each character entry includes at least one of the avatar, the character name, the note information option, the check box corresponding to the note information option and the note control of the corresponding virtual object. Here, a note control corresponding to the virtual object may be included in each character entry, or a note control may be generated for the note list, and the note information may be added by dragging the note control to a position where the specified character entry is located.

The second virtual object is a virtual object controlled by another game player in the game match except the first virtual object. For example, the second virtual object may be a virtual object corresponding to another game player in the game except for the account logging in the game client on the terminal device in the game.

It should be noted that the note list may further include a subset of the first virtual object, and the subset of the first virtual object may also include an identity information option and a check box corresponding to the identity information option, or may not include the above content, since the game player using the terminal device knows his/her identity information in the game, and therefore there is no need to mark his/her identity information.

In response to the note addition operation of the game player, the terminal device in embodiments of the present disclosure displays the note list in the graphical user interface, and displays the note prompt information of the at least one second virtual object in the note list. Through the displayed note list, the note prompt information of the at least one second virtual object can be intuitively displayed, so as to facilitate the game player to mark the identity of the second virtual object.

In embodiments of the present disclosure, the step S130 further includes:
displaying note prompt information of at least one third virtual object in the note list, the at least one second virtual object may be a virtual object in an alive state, and the at least one third virtual object may be a virtual object in a dead state.

Here, the second virtual object refers to a virtual object that can continue to perform the task in the current game match, that is, the virtual object in the alive state. The third virtual object refers to a virtual object that has been eliminated in the game match, that is, the virtual object in the dead state.

Furthermore, the note list may further include the note prompt information of the third virtual object which is in the dead state. The game player who controls the first virtual object may mark the identity information of the third virtual object. In addition, if the identity (referring to the identity randomly assigned to the player by the game server when the player initially enters the game) of the third virtual object in the current game match has been revealed, the identity information of the third virtual object that is already known may be displayed in the note list. In addition, a display state of the third virtual object in the note list may also be distinguished. For example, a subset of the third virtual object is marked as black and white and/or an un-editable state.

In addition, the first virtual object controlled by the current game player may further be displayed in the note list, and note prompt information of the first virtual object may further be displayed in the note list to add the note information to the first virtual object.

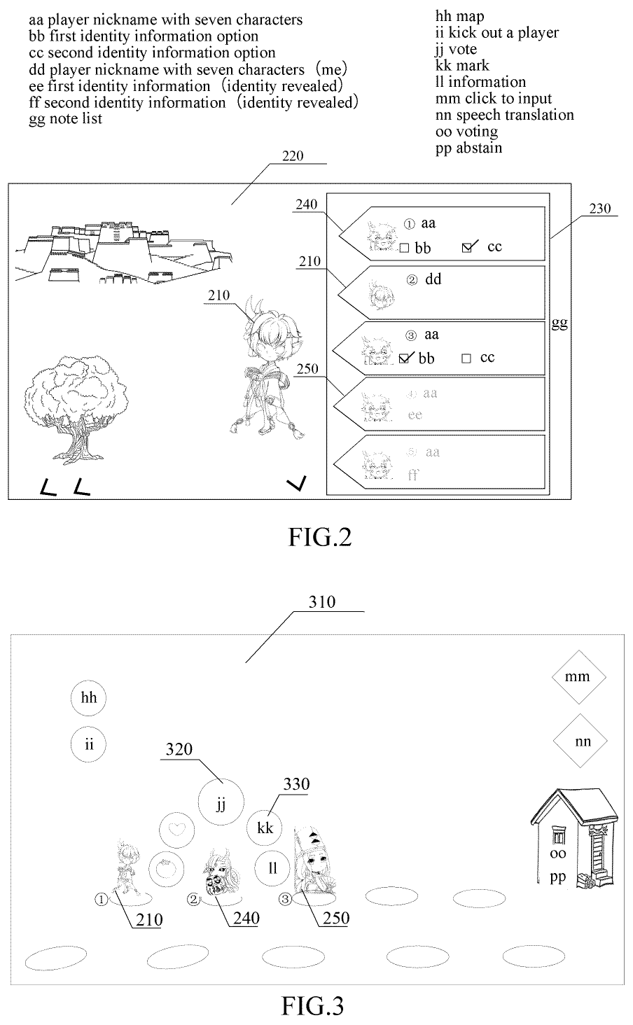

For example, as shown in FIG. 2, a first virtual object 210 is in a first virtual scene 220, and a note list 230 includes a character nickname and an identity information option (such as a first identity information option indicating first identity information and a second identity information option indicating second identity information) corresponding to a second virtual object 240. A check box is provided at a position near the identity information option, and the check box is used to respond to a check operation upon the selection of the identity information. The note list 230 further includes a character nickname corresponding to the first virtual object 210, and a character nickname and the already known identity information corresponding to a third virtual object 250. In addition, the list of the third virtual object is marked gray. The character attribute indicating the identity information is taken as example for illustration in the above examples. It should be understood that the present disclosure is not limited to this, and the character attribute may also be represented by other information.

In embodiments of the present disclosure, the step S130 further includes:
displaying the note prompt information of the at least one second virtual object in the note list according to a display priority of second virtual object, and the display priority is determined according to a distance between the at least one second virtual object and the first virtual object.

Here, the display priority refers to a display order of the second virtual object in the note list when the terminal device displays the note prompt information of the second virtual object. A second virtual object with a higher display priority is displayed at the front of the note list, and a second virtual object with a lower display priority is displayed at the back of the note list.

In an embodiment of the present disclosure, the display priority is determined according to the distance between the at least one second virtual object and the first virtual object. Specifically, distances between all second virtual objects and the first virtual object in the first virtual scene are first determined, and the note prompt information of the second virtual objects is arranged according to the determined distances from small to large, so as to obtain the note list. Here, the closer the second virtual object is to the first virtual object, the more convenient it is for the first virtual object to observe and track the behavior information of the second virtual object, and the more convenient it is for the first virtual object to reason about the identity of the second virtual object.

In embodiments of the present disclosure, the step S130 further includes:
displaying the at least one second virtual object and a note control in the note list, and displaying the note prompt information of the at least one second virtual object in the note control.

Here, the note control refers to a control that can display the note prompt information of the second virtual object. The note control may be provided around the second virtual object, or may be displayed at another position on the graphical user interface.

In a first case, one sub-set in the note list includes one second virtual object and a note control corresponding to this second virtual object. When the game player corresponding to the first virtual object wants to add the note information to a certain second virtual object, in response to a selection operation for an avatar of a target virtual object (the target second virtual object marked) in the note list, some controls will appear around the target virtual object, including the note control. The note prompt information will be displayed in the note control. In response to a selection operation for the note control, the note information is added to the target virtual object based on the note prompt information corresponding to the selected note control, and the added note information will be displayed around the target virtual object.

In a second case, at least one second virtual object and one note control are displayed in the note list. When the game player corresponding to the first virtual object wants to mark a certain second virtual object, the game player clicks on the note control in the note list, and the note control will display the note prompt information of the at least one second virtual object. The note prompt information corresponding to the target virtual object is found from the displayed note prompt information of the at least one second virtual object. The note information added to the target virtual object is determined according to the note prompt information corresponding to the target virtual object, and the added note information will be displayed around the target virtual object.

In a third case, at least one second virtual object and one note control are displayed in the note list. When the game player corresponding to the first virtual object wants to mark a certain second virtual object, the note control will display at least one piece of note prompt information for the second virtual object, and target note information (note information that the game player corresponding to the first virtual object wants to mark the second virtual object) is determined from the displayed at least one piece of note prompt information. In response to a drag operation for the note control in the note list corresponding to the determined target note information, the determined target note control is dragged to the target virtual object, so that the added note information is displayed around the target virtual object.

In embodiments of the present disclosure, the method for displaying the information of the virtual object may further include: in response to a preset trigger event, displaying a second virtual scene in the graphical user interface; and visually marking the second virtual object according to the note prompt information. Here, the second virtual scene includes the at least one second virtual object.

Here, the trigger event refers to a switching action of switching from the first virtual scene to the second virtual scene. For example, the switching action may include a return operation to exit the first virtual scene, and an opening operation of clicking on a start button of the second virtual scene. In response to the preset trigger event, the graphical user interface is switched from the first virtual scene to the second virtual scene, and the second virtual scene includes the first virtual object and the at least one second virtual object, and may further include the third virtual object.

Specifically, what is displayed in the second virtual scene may be a character model of the second virtual object or a character icon of the second virtual object. Similarly, what is displayed in the second virtual scene may also be character models of the first virtual object and/or the third virtual object, or character icons of the first virtual object and/or the third virtual object.

In this implementation, the second virtual scene is a virtual scene corresponding to the above-mentioned discussion stage. In the discussion stage, the terminal device enters the discussion stage in response to an end operation of the action stage and an opening operation of the discussion stage. The discussion stage includes virtual objects with different character attributes that are in the alive state in the action stage and virtual objects with different character attributes that are in the elimination state (may also be called the dead state), and the virtual objects in the elimination state cannot perform voting-related operations in this discussion stage.

In embodiments of the present disclosure, the note prompt information may include a plurality pieces of identity information configured to indicate an identity of a virtual object, and the note information includes an identity identifier; and the step S140 includes: in response to a selection operation for target identity information, displaying an identity identifier corresponding to the selected target identity information at a preset position corresponding to the target virtual object.

Specifically, the note information is added to the target virtual object, so as to control to display the note information around the target virtual object. When the first virtual object moves in the first virtual scene according to the movement operation, and the first virtual scene range displayed in the graphical user interface is controlled, according to the movement of the first virtual object, to change accordingly, if the target virtual object appears within a preset range of the first virtual object, the player can see the target virtual object and the note information of the target virtual object through the first virtual scene presented in the graphical user interface.

Correspondingly, the note information is added to the target virtual object to control to display the note information around the target virtual object. When the second virtual scene is displayed in the graphical user interface in response to the preset trigger event, if the target virtual object appears in the second virtual scene, the player can see the target virtual object and the note information of the target virtual object through the second virtual scene presented in the graphical user interface.

Here, the plurality pieces of identity information is used to represent all possible identity information that the virtual object has (such as all identities that each player can have set by the game server for this game), and the identity identifier is used to represent the identity information inferred by the current player for the virtual object. The added note information is only visible to the current player. In one case, the displayed identity identifier is the same as the target identity information, that is, the content displayed in the identity identifier is the target identity information itself. In this way, the identity identifier displayed at the preset position corresponding to the target virtual object is the target identity information. In another case, a specific label or a specific color can be used for the identity identifier to indicate the target identity information. For example, numbers such as 1, 2 . . . , etc., letters such as a, b . . . , etc., or different colors such as red, green, yellow, etc., are used to replace the identity identifiers corresponding to different identity information.

The selection operation refers to an operation of determining the target identity information from the plurality pieces of identity information, included in the note prompt information, used to indicate the identity of the virtual object. The preset position refers to a position used to display the identity identifier, and this position may be located around the target virtual object. The added note information can follow the movement of the target virtual object in the virtual scene.

In this way, in response to the selection operation by the game player for the target identity information, the terminal device displays the identity identifier corresponding to the selected target identity information at the preset position corresponding to the target virtual object, so that the identity identifier is displayed to the game player corresponding to the first virtual object or a game player who belongs to the same camp as the first virtual object, so that the game player can more clearly learn the identity information of other game players.

In embodiments of the present disclosure, the method for displaying the information of the virtual object may further include: when displaying a second virtual scene in the graphical user interface, displaying an identity voting control of the at least one second virtual object in the graphical user interface; and in response to a voting operation on the identity voting control, performing a corresponding voting instruction.

Here, the identity voting control refers to a control that can respond to the voting operation. The terminal device completes the voting on the virtual object in response to the voting operation on the identity voting control.

In the implementation, during the discussion stage, virtual objects controlled by a plurality of game players are displayed in the graphical user interface, and these virtual objects include virtual objects with different character attributes. For virtual objects in the alive state, they all have the identity voting control, and the game players themselves also have the identity voting control. The game player can vote for the virtual object with a suspicious identity by clicking on the identity voting control corresponding to the virtual object that the game player believes has the suspicious identity.

In embodiments of the present disclosure, the second virtual scene includes a plurality of virtual objects, and the plurality of virtual objects may include the first virtual object, the at least one second virtual object, and/or the at least one third virtual object. The at least one second virtual object is a virtual object in the alive state, and the at least one third virtual object is a virtual object in the dead state. The method for displaying the information may further include: in response to the note addition operation, displaying note prompt information of the at least one second virtual object and/or the at least one third virtual object in the graphic user interface; and in response to the trigger operation for the note prompt information, adding note information to a target virtual object among the at least one second virtual object and/or the at least one third virtual object displayed.

Here, the second virtual scene including the plurality of virtual objects may be divided into three cases. In a first case, it may include the first virtual object and the at least one second virtual object. In a second case, it may include the first virtual object and the at least one third virtual object. In a third case, it may include the first virtual object, the at least one second virtual object and the at least one third virtual object.

For the first case, in the second virtual scene, in response to the note addition operation, note prompt information of the first virtual object and the at least one second virtual object is displayed in the graphical user interface; and in response to the trigger operation for the note prompt information, note information is added to a target virtual object among the displayed first virtual object and at least one second virtual object.

For the second case, in the second virtual scene, in response to the note addition operation, note prompt information of the first virtual object and the at least one third virtual object is displayed in the graphical user interface; and in response to the trigger operation for the note prompt information, the note information is added to a target virtual object among the displayed first virtual object and at least one third virtual object.

For the third case, in the second virtual scene, in response to the note addition operation, note prompt information of the first virtual object, the at least one second virtual object and the at least one third virtual object is displayed in the graphical user interface; and in response to the trigger operation for the note prompt information, the note information is added to a target virtual object among the displayed first virtual object, at least one second virtual object, and at least one third virtual object.

The above-mentioned responding to the note addition operation and the trigger operation for the note prompt information in the second virtual scene has the same concept as the responding to the note addition operation and the trigger operation for the note prompt information in the first virtual scene, and the repetitive parts will not be given again.

In embodiments of the present disclosure, the at least one second virtual object refers to a plurality of second virtual objects, and the step of displaying the note prompt information of the at least one second virtual object in the graphical user interface in response to the note addition operation may include: in response to a multi-selection operation for the plurality of second virtual objects, displaying the note prompt information on a periphery of any of the plurality of second virtual objects, that is, around any of the plurality of second virtual objects.

Here, the multi-selection operation refers to making the plurality of second virtual objects respond to the note addition operation at the same time. For each of the plurality of second virtual objects, the note prompt information is displayed on the periphery of this second virtual object in response to the note addition operation. The periphery is a peripheral position of any second virtual object.

In embodiments of the present disclosure, during the discussion stage, the game player himself can view the note information added for the virtual objects controlled by a plurality of other players during the action stage and/or the discussion stage, and further, can vote during the discussion stage with reference to the note information for each virtual object, which can improve the voting efficiency of the game player.

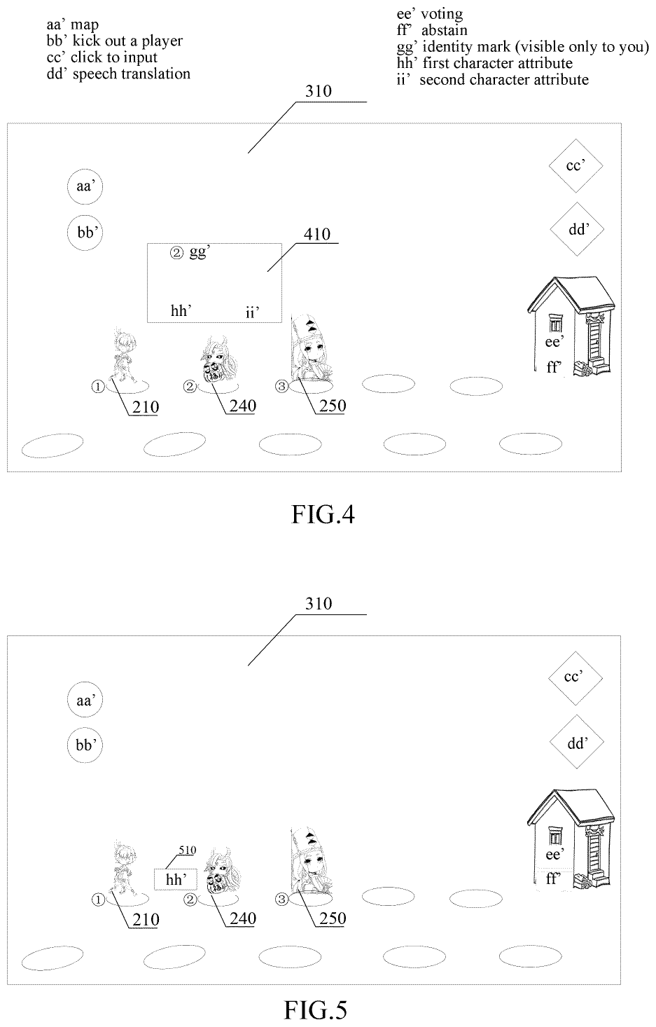

To sum up, for example, as shown in FIG. 3, a second virtual scene 310 may include the first virtual object 210, the second virtual object 240 and the third virtual object 250, and an identity voting control 320 and a note control 330 for the second virtual object 240 are displayed in the graphical user interface. By clicking on the identity voting control 320, the system can execute a voting instruction, and the note control 330 can display the note prompt information of the second virtual object. Furthermore, as shown in FIG. 4, note prompt information 410 includes different character attributes (such as the first character attribute and the second character attribute). The game player makes inferences based on the behavior information of the second virtual object 240 in the action stage to determine the identity information of the virtual object 240 and add the note information to it. After the completion of the addition of the note information to the second virtual object 240, as shown in FIG. 5, the second virtual object 240 will be displayed with an identity identifier 510. Here, the identity identifier 510 corresponds to the first character attribute.

In embodiments of the present disclosure, the step of displaying the note prompt information of the at least one second virtual object in the graphical user interface in response to the note addition operation may include: in response to the note addition operation, generating a note control and a screenshot image corresponding to the current graphical user interface, the screenshot image includes the at least one second virtual object, and the note prompt information of the at least one second virtual object is displayed in the note control. Here, the screenshot image may further include the first virtual object and/or the at least one third virtual object.

Here, the screenshot image refers to a static image captured for the virtual scene displayed by the current graphical user interface. For example, a virtual scene range included in the screenshot image may be equal to or smaller than a virtual scene range displayed by the current graphical user interface. The screenshot image includes the at least one second virtual object. The note control refers to a control capable of displaying the note prompt information of the second virtual object, and the note prompt information of the at least one second virtual object is displayed in the note control.

The note addition operation in embodiments of the present disclosure may be a screenshot operation. Furthermore, in response to the screenshot operation of the game player, the terminal device generates the note control and the screenshot image corresponding to the current graphical user interface. The note prompt information of the second virtual object is determined, through a position of the note control on the screenshot image, to be displayed in the graphical user interface.

In embodiments of the present disclosure, the step of adding the note information to the target virtual object among the at least one second virtual object displayed in response to the trigger operation for the note prompt information may include: in response to a drag operation for the note control, dragging the note control to a position where the target virtual object is located, to add note prompt information corresponding to the dragged note control to the target virtual object.

Here, the note prompt information is added to the target virtual object by dragging the note control to the position in the screenshot image where the target virtual object is located. The note control may directly display the note prompt information, or it may only provide a display entry for the note prompt information.

In embodiments of the present disclosure, the method for displaying the information of the virtual object may further include: storing the screenshot image including the target virtual object with the added note information, and recording a note time; and in response to a note viewing operation, displaying the stored screenshot image in the graphical user interface according to the note time.

Here, the screenshot image including the virtual object with the note information is saved, and the note time for adding the note information to the virtual object is saved at the same time. In this way, the stored screenshot image is displayed in the graphical user interface according to the note time, in response to the note viewing operation of the game player, which facilitates the game player to clearly obtain the note information of the target virtual object.

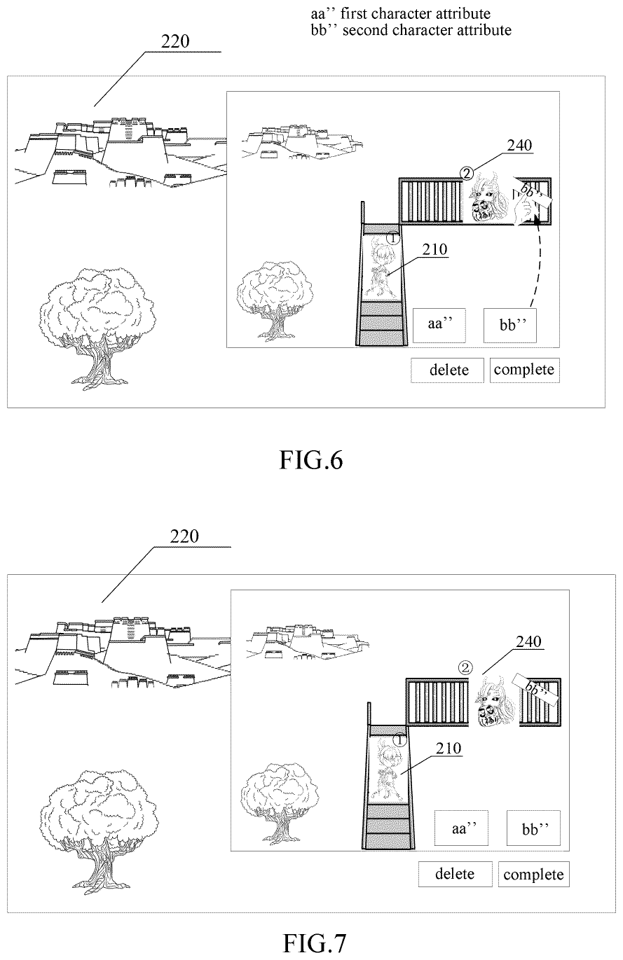

In embodiments of the present disclosure, photo taking and photo album entry buttons are added to the graphical user interface. As shown in FIG. 6, the game player takes a photo and marks the identity. When taking the photo, the game player needs to record position information of each virtual object in the picture, and when marking, the game player associates the virtual object according to the position information, and then drags a tag for marking. After the effective marking is completed, a case shown in FIG. 7 may be obtained. Specifically; after the photo is taken, there is a need to make a note by the game player, and the dragging manner is used for marking. When the dragging is to the corresponding character, a response area needs to have a feedback. For example, there is no feedback (no marking is available) when the dragging is to the position where the virtual object controlled by the current player is located. The mark can be deleted by dragging the note information displayed on the virtual object outside the screenshot image. When the mark is to be cleared, the note control is dragged from the response area to outside the response area (when the note control is in the response area, the response area is displayed, and an identity mark control is only displayed during the edition of the screenshot, and when an album interface is displayed later, the identity mark control is not displayed, to avoid conflicts in which the same player is marked multiple times in the plurality of photos).

When the screenshot image is replaced, the “Complete” button is clicked to close the interface before replacing. Deleting the photo requires confirmation (general confirmation interface), and deleting the screenshot image will not clear the identity mark of the corresponding screenshot image. After the effective marking is completed, this mark is dragged outside the image to delete it. That is, when the mark is to be cleared, the note control is dragged from the response area to outside the response area (when the note control is in the response area, the response area is displayed).

In the image list, the recently saved screenshot image is displayed at the top of the image list. By default, a first screenshot image at the top of the image list is displayed in a preview area. The screenshot image displays a capturing time, such as xx minutes and XX seconds ago. When the number of saved screenshot images reaches the maximum storage limit, the screenshot image stored first will be deleted.

In embodiments of the present disclosure, the method for displaying the information of the virtual object may further include: displaying the added note information on a periphery of the target virtual object.

Here, the periphery refers to a position around the target virtual object with the target virtual object as the center. When the note information added to the target virtual object is determined, the added note information is displayed around the target virtual object.

Specifically; the display form of the added note information includes but is not limited to: displaying the added note information in the form of keywords of the added note information, such as most suspicious, relatively suspicious, etc.; using a character to replace the added note information, so as to display the added note information in the form of label, for example, the first character attribute is represented by the character 1, and the second character attribute is represented by the character 2.

In some embodiments of the present disclosure, if the target virtual object and the first virtual object belong to teammates and the attribute information of the target virtual object is known, the added note information and the known attribute information are displayed around the target virtual object.

Here, the attribute information refers to identity attribute information assigned to the virtual object in the game match which the virtual object is in by the game server when it initially enters the game. The identity information of the first virtual object being the specific identity information means that teammates in the same camp can see each other's identity attribute information.

When both the target virtual object and the first virtual object have specific identity information, in the game match, the first virtual object can see the attribute information of the target virtual object, but the game player can still add the note information to the target virtual object. In this way, upon display; the added note information and the known attribute information can be displayed around the target virtual object.

In an embodiment of the present disclosure, it is assumed that respective virtual characters in the game match belong to different camps based on different assigned character attributes, for example, belong to a first camp and a second camp, individual virtual characters belonging to the first camp can know each other's identity information (referring to a real identity of the virtual character, that is, the identity assigned by the game server). However, during the action stage and the discussion stage, individual virtual characters belonging to the first camp may disguise their identities in order to interfere the task execution of the virtual character belonging to the second camp or mislead the voting of the virtual character belonging to the second camp. In addition, in order to avoid the wrong voting of the virtual characters belonging to the same first camp during the discussion stage, the game player may also add note information to teammates to ensure that their character attributes are clear. In addition, the note information may further include some behavior information. In this way, marking some behavior information for teammates can mislead the virtual characters of other camps to vote based on the marked behavior information during the discussion stage.

In the method for displaying the information of the virtual object provided by embodiments of the present disclosure, the note information is added to the virtual object of the other player in the game, so that it is easy for the player to record the identity information of the other player that has been inferred during the game, and the note addition operation is relatively convenient, which can prevent the player from forgetting the identity information corresponding to the other player that has been inferred. In addition, a player with a suspicious identity is determined based on the identity information of the player that has been inferred, so that the player can avoid the player with the suspicious identity when taking action. In this way, the gaming efficiency of the player can be improved.

In the action stage, there are usually functions one to eight. In the discussion stage, there are usually functions one, two and seven.

Function One. This embodiment provides a display function of a virtual map. In response to a movement operation on a first virtual object, the first virtual object is controlled to move in a first virtual scene, and a range of the first virtual scene displayed in a graphical user interface is controlled to correspondingly change according to the movement of the first virtual object; and in response to a preset trigger event, the virtual scene displayed in the graphical user interface is controlled to be switched from the first virtual scene to a second virtual scene, and the second virtual scene includes at least one second virtual object.

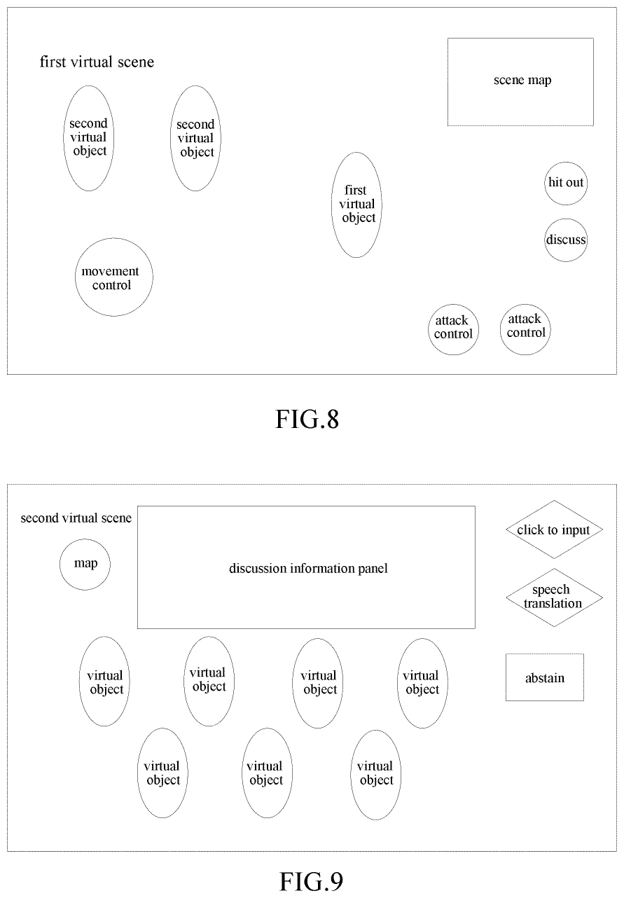

In this embodiment, the description is made from the perspective of a first virtual object with a target identity. The first virtual scene is first provided in the graphical user interface, as shown in FIG. 8, in which the virtual object can move, or perform a game task, or perform other interactive operations. The user triggers a movement operation for the first virtual object to control the movement of the first virtual object in the first virtual scene, and in most cases, the first virtual object is located in a position at a relative center of a range of the first virtual scene displayed in the graphical user interface. The virtual camera in the first virtual scene moves following the movement of the first virtual object, which in turn causes the range of the first virtual scene displayed in the graphical user interface to change correspondingly according to the movement of the first virtual object.

The virtual objects participating in the current game match are in the same first virtual scene. Therefore, during the movement of the first virtual object, if the first virtual object is closer to the other virtual objects, there may be other virtual objects entering into the range of the first virtual scene displayed in the graphical user interface, which are characters controlled by the other players. As shown in FIG. 8, there are two nearby second virtual objects displayed in the range of the first virtual scene, in addition to which there is displayed in the graphical user interface a movement control for controlling the movement of the first virtual object, a plurality of attack controls, and a discussion control. The discussion control may be configured to control the virtual objects to enter the second virtual scene.

When the user controls the first virtual object to move in the first virtual scene, the user may determine the target virtual object from a plurality of second virtual objects in an alive state. The plurality of second virtual objects in the alive state may refer to the virtual objects in the alive state other than the first virtual object in the current game match. Specifically, the user may determine the target virtual object based on the position, behavior, etc. of each of the second virtual objects. For example, the user selects a virtual object as the target virtual object that is relatively isolated and is not easily detected by other virtual objects when attacking. After the target virtual object is determined, it may be controlled to move in the first virtual scene to the position of the target virtual object from an initial position, and a specified operation may be performed on the target virtual object, and then the target virtual object enters a target state.

The second virtual scene is displayed in the graphical user interface upon the triggering of the preset trigger event. For example, the trigger event may be a specific trigger operation, which may be performed by any virtual object in the alive state. For example, in FIG. 5, the second virtual scene may be displayed in the graphical user interface by triggering the discussion control, thereby realizing that the virtual scene is switched from the first virtual scene to the second virtual scene, and all virtual objects in the current game match are moved from the first virtual scene to the second virtual scene. The second virtual scene includes at least one second virtual object or its object icon in addition to the first virtual object or an object icon of the first virtual object, where the object icon may be an avatar, a name, etc., of the virtual object.

In the second virtual scene, the virtual object in the alive state has the permission to speak, discuss and vote, but the target virtual object enters the target state, resulting in at least some of the interactions configured for the target virtual object in the second virtual scene being in a restricted state. The interactions may include speaking, discussing and voting interactions, etc. The restricted state may be that a certain interaction is not allowed, or a certain interaction is not allowed within a certain period of time, or a certain interaction is limited to a specified number of times.

As shown in FIG. 9, the second virtual scene includes a plurality of virtual objects in the alive state, including the first virtual object. The first virtual object may send a discussion message through a “Click to Input” control and a “Speech Translation” control on the right side. The discussion message sent by the virtual object may be displayed on a discussion message panel, and the discussion message may include who initiates the discussion, who is attacked, the position of the virtual object that is attacked, and the position of each virtual object upon the initiation of the discussion, etc.

The user may vote for a virtual object by clicking on the virtual object in the second virtual scene to display a voting button for the virtual object in the vicinity of the virtual object. The user may also click on an abstain button to give up the voting right for this time.

In response to a touch operation for a function control, a position marking interface is displayed in the graphical user interface, and in the position marking interface, a character identifier of the at least one second virtual object and/or the first virtual object is displayed based on the position marking information reported by the at least one second virtual object and/or the first virtual object.

Function Two. This embodiment provides an information display function for a virtual object. A first virtual scene and a first virtual object located in the first virtual scene are displayed in a graphical user interface. In response to a movement operation for the first virtual object, the first virtual object is controlled to move in the first virtual scene, and a first virtual scene range displayed in the graphical user interface is controlled, according to movement of the first virtual object, to change accordingly.

In this embodiment, the description is made from the perspective of the first virtual object with a target identity. The first virtual scene is first provided in the graphical user interface, as shown in FIG. 8, in which the virtual object can move, or perform a game task, or perform other interactive operations. The user triggers a movement operation for the first virtual object to control the movement of the first virtual object in the first virtual scene, and in most cases, the first virtual object is located in a position at a relative center of a range of the first virtual scene displayed in the graphical user interface. The virtual camera in the first virtual scene moves following the movement of the first virtual object, which in turn causes the range of the first virtual scene displayed in the graphical user interface to change correspondingly according to the movement of the first virtual object.

The virtual objects participating in the current game match are in the same first virtual scene. Therefore, during the movement of the first virtual object, if the first virtual object is closer to the other virtual objects, there may be other virtual objects entering into the range of the first virtual scene displayed in the graphical user interface, which are characters controlled by the other players, or non-player controlled virtual characters. As shown in FIG. 8, there are two nearby second virtual objects displayed in the range of the first virtual scene, in addition to which there is displayed in the graphical user interface a movement control for controlling the movement of the first virtual object, a plurality of attack controls, and a discussion control. The discussion control may be configured to control the virtual object to enter the second virtual scene.

When the user controls the first virtual object to move in the first virtual scene, the user may determine the target virtual object from at least one second virtual object in an alive state, and/or at least one third virtual object in a dead state. The at least one second virtual object in the alive state may refer to the virtual object(s) in the alive state other than the first virtual object in the current game match. Specifically, the user may determine the target virtual object based on the position, the behavior, etc. of each of the second virtual objects. For example, the user selects a virtual object as the target virtual object that is relatively isolated and is not easily detected by other virtual objects upon attacking. The user may also select a virtual object as the target virtual object that has suspicious identity information reasoned based on the position, the behavior, etc. After the target virtual object is determined, the e target virtual object may be controlled to move to the position of the target virtual object from an initial position in the first virtual scene, or the target virtual object may be selected, so that specified operations may be performed on the target virtual object, and then the target virtual object enters a target state.

For example, in response to a note addition operation, note prompt information is displayed for at least one second virtual object in the graphical user interface; and in response to a trigger operation for the note prompt information, note information is added for a target virtual object among the at least one second virtual object displayed. In this case, the note information may be displayed on the peripheral side of the target virtual object in the first virtual scene, that is, when the first virtual object is moved in the first virtual scene according to the movement operation and the range of the first virtual scene displayed in the graphical user interface is controlled to correspondingly change according to the movement of the first virtual object, if the target virtual object appears in a preset range of the first virtual object, the player may see the target virtual object as well as the note information of the target virtual object through the first virtual scene presented in the graphical user interface.

The second virtual scene is displayed in the graphical user interface upon the triggering of the preset trigger event. For example, the trigger event may be a specific trigger operation, which may be performed by any virtual object in the alive state. For example, in FIG. 8, the second virtual scene may be displayed in the graphical user interface by triggering the discussion control, thereby realizing that the virtual scene is switched from the first virtual scene to the second virtual scene, and all virtual objects in the current game match are moved from the first virtual scene to the second virtual scene. The second virtual scene includes at least one second virtual object, or its character model and character icon, in addition to the first virtual object, or its character model and object icon, where the character icon may be an avatar, a name, etc., of the virtual object.

In the second virtual scene, the virtual object in the alive state has the permission to speak, discuss and vote, and if the target virtual object enters the target state (e.g., added with the note information), the current player can see the target virtual object and the note information of the target virtual object through the second virtual scene presented in the graphical user interface. In addition, the second virtual scene is also configured with interaction modes, which may include speaking and discussing interactions, voting interactions, note interactions, and the like. A state in which the use of the interaction mode is restricted may be that a certain interaction mode is not allowed, or a certain interaction mode is not allowed within a certain period of time, or a certain interaction mode is limited to a specified number of times. For example, a virtual character in a dead state is restricted from using the voting interaction, and a virtual character in a dead state whose identity is known is restricted from using the note interaction.

As shown in FIG. 9, the second virtual scene includes a plurality of virtual objects in the alive state, including the first virtual object. The first virtual object can send a discussion message through a “Click to Input” control and a “Speech Translation” control on the right side. The discussion message sent by the virtual object may be displayed on a discussion message panel, and the discussion message may include who initiates the discussion, who is attacked, the position of the virtual object that is attacked, and the position of each virtual object upon the initiation of the discussion, etc.

The user may vote for a virtual object by clicking on the virtual object in the second virtual scene to display a voting button for the virtual object in the vicinity of the virtual object. The user may also click on an abstain button to give up the voting right for this time. Additionally, a note control may be displayed along with the voting button to add note information to the clicked virtual object based on a touch operation for the note control.

In addition, a note list may also be displayed in the second virtual scene, and the note prompt information may be displayed in the note list in order to add note information to the displayed target virtual object in response to a trigger operation for the note prompt information. Specific implementations of the process may be referred to in the embodiments described above.

Function Three. This embodiment provides a control function of a game progress. In an action stage, at least part of a first virtual scene of the action stage and a first virtual object located in the first virtual scene are displayed in a graphical user interface. A skill configuration parameter of the first virtual object is obtained to determine an additional skill, newly added on the basis of a character default skill, of the first virtual object, and the default skill is a skill assigned according to an identity attribute of the first virtual object. When it is determined that a virtual task completion progress in a game stage has reached a progress threshold, the first virtual object is controlled to unlock the additional skill, and an additional skill control configured to trigger the additional skill is provided, on the basis of providing a default skill control configured to trigger the default skill in the graphical user interface. In response to a preset trigger event, the graphical user interface is controlled to display a second virtual scene corresponding to a discussion stage. The second virtual scene includes at least one of: a second virtual object, a character icon of the second virtual object, the first virtual object, and a character icon of the first virtual object. The discussion stage is configured to determine a game state of at least one second virtual object or the first virtual object based on a result of the discussion stage. Specific implementations of the process may be referred to in the embodiments described below.

In this embodiment of the present disclosure, the description is made from the perspective of the first virtual object with a first character attribute. A first virtual scene is first provided in the graphical user interface, as shown in FIG. 8, in which the first virtual object can move, or perform a game virtual task, or perform other interactive operations. The user triggers a movement operation for the target virtual object to control the movement of the first virtual object in the first virtual scene, and in most cases, the first virtual object is located in a position at a relative center of a range of the first virtual scene displayed in the graphical user interface. The virtual camera in the first virtual scene moves following the movement of the first virtual object, which in turn causes the range of the first virtual scene displayed in the graphical user interface to change correspondingly according to the movement of the first virtual object.

When the user controls the first virtual object to move in the first virtual scene, the additional skill of the first virtual object newly added on the basis of the character default skill is determined based on the skill parameter of the first virtual object. The additional skill may include at least one of: an identity gambling skill, an identity verification skill, a guidance skill, and a task doubling skill. It is also determined the virtual task progress jointly completed by a plurality of other virtual objects having the same character attribute (the first character attribute) as the first virtual object in the current game stage, which is displayed based on the shown progress bar. When it is determined that the virtual task completion progress in the game stage has reached the progress threshold, the first virtual object may be controlled to unlock the additional skill, and the first virtual object utilizes the additional skill to play the game. For example, the guidance skill may be used to determine, during the action stage, the virtual object in the first virtual scene that is in a target state (e.g., dead, etc.) and within a preset distance threshold from the first virtual object, so that the first virtual object may be controlled to move to the position of the virtual object in the target state, and a discussion may be initiated immediately.

The second virtual scene is displayed in the graphical user interface upon the triggering of the preset trigger event. For example, the trigger event may be a specific trigger operation, which may be performed by any virtual object in the alive state. For example, in FIG. 8, the second virtual scene may be displayed in the graphical user interface by triggering the discussion control, thereby realizing that the virtual scene is switched from the first virtual scene to the second virtual scene, and all virtual objects in the current game match are moved from the first virtual scene to the second virtual scene. The second virtual scene includes at least one second virtual object or its object icon in addition to the first virtual object and an object icon of the first virtual object, where the object icon may be an avatar, a name, etc., of the virtual object.

In the second virtual scene, the virtual object in the alive state has the permission to speak, discuss and vote. As shown in FIG. 9, the second virtual scene includes a plurality of virtual objects in the alive state, including the first virtual object. The first virtual object may send a discussion message through a “Click to Input” control and a “Speech Translation” control on the right side. The discussion message sent by the virtual object may be displayed on a discussion message panel, and the discussion message may include who initiates the discussion, who is attacked, the position of the virtual object that is attacked, and the position of each virtual object upon the initiation of the discussion, etc.

The user may vote for a virtual object by clicking on the virtual object in the second virtual scene to display a voting button for the virtual object in the vicinity of the virtual object. Before voting, the user can control the first virtual object to use the corresponding unlocked additional skill to check the virtual object of key suspicion. For example, the first virtual object can use the identity verification skill to check the identity of the virtual object of key suspicion, and based on the check result, determine whether to vote for the virtual object to improve the accuracy of the vote. Note that, the user can also click on an abstain button to give up the voting right for this time.

Function Four. This embodiment provides another display function of a virtual map. In response to a movement operation, a virtual character is controlled to move in a virtual scene and the virtual scene to which the virtual character is currently moved is displayed in a graphical user interface.

In this embodiment, the description is made from the perspective of a virtual object controlled by a player. A virtual scene is provided in the graphical user interface, as shown in FIG. 8. In this virtual scene (e.g., the first virtual scene as shown in FIG. 8), the virtual character (e.g., the first virtual character and/or the second virtual character as shown in FIG. 8) controlled by the player can move in the virtual scene, or perform a game task, or perform other interactive operations. In response to a movement operation triggered by the player, the virtual object is controlled to move in the virtual scene, and in most cases, the virtual object is located in a position at a relative center of a range of the virtual scene displayed in the graphical user interface. The virtual camera in the virtual scene follows the movement of the virtual object, which in turn causes the virtual scene displayed in the graphical user interface to change in correspondence to the movement of the virtual object, thus the virtual scene to which the virtual character is currently moved is displayed in the graphical user interface.

The virtual objects participating in the current game match are in the same virtual scene. Therefore, during the movement of the virtual object, if the virtual object is closer to the other virtual objects, there may be other virtual objects entering into the range of the virtual scene displayed in the graphical user interface, which are characters controlled by the other players. As shown in FIG. 9, there are a plurality of virtual objects displayed in the range of the virtual scene, in addition to which there is displayed in the graphical user interface a movement control for controlling the movement of the virtual object, a plurality of attack controls, and a discussion control. The discussion control may be configured to control the virtual objects to enter the second virtual scene as shown in FIG. 9.

In response to a map display operation triggered by the user, a first virtual map is displayed superimposed on top of the virtual scene displayed in the graphical user interface. For example, in response to a touch operation by the game player on a thumbnail of the scene (such as the scene map shown in FIG. 8), the first virtual map is displayed superimposed over the virtual scene. For example, in response to a control operation that controls the virtual character to perform a second specific action, the first virtual map is displayed superimposed over the virtual scene. Here, the first virtual map includes at least a current position of the first virtual character, a position of each first virtual area in the virtual scene, a position of a connected area, and the like.

When the map switching condition is triggered, the first virtual map superimposed on the virtual scene in the graphical user interface is switched to the second virtual map corresponding to the virtual scene, where at least a portion of the map area of the second virtual map has a higher transparency than the transparency of the map area corresponding to the first virtual map, so that the degree of occlusion of the information in the virtual scene by the switched virtual map is lower than the degree of occlusion before the switching. For example, the map switching condition may be a specific trigger operation, which may be performed by the virtual object in the alive state. For example, in response to a control operation controlling the virtual object to perform a first specific action, the first virtual map superimposed on the virtual scene is switched to the second virtual map corresponding to the virtual scene. For another example, the first virtual map superimposed on the virtual scene is switched to the second virtual map corresponding to the virtual scene by triggering a map switching button.

When the map switching condition is triggered, the first virtual map may be switched to the second virtual map by a specific switching method, which may be, for example, replacing the first virtual map superimposed on the virtual scene with the second virtual map corresponding to the virtual scene; or, adjusting the first virtual map to a state where the first virtual map is not visible in the current virtual scene in accordance with a first change threshold of transparency, and replacing the first virtual map superimposed on the virtual scene with the second virtual map corresponding to the virtual scene; or clearing the first virtual map superimposed on the virtual scene, and superimposing and displaying the second virtual map in the virtual scene in accordance with a second change threshold of transparency; or, in accordance with a third change threshold of transparency, adjusting the transparency of the first virtual map, and at the same time, in accordance with a fourth change threshold of transparency; superimposing and displaying the second virtual map on the virtual scene, until the first virtual map is in a state where the first virtual map is not visible in the current virtual scene.

Function Five. This embodiment provides a target attack function in a game. In response to a movement operation for a first virtual object, the first virtual object is controlled to move in a first virtual scene and a range of the first virtual scene displayed in a graphical user interface is controlled to change in accordance with the movement of the first virtual object. A temporary virtual object is controlled to move from an initial position to a position of a target virtual object in the first virtual scene and to perform a specified operation on the target virtual object, so as to make the target virtual object to enter a target state. The temporary virtual object is a virtual object controlled by the first virtual object with a target identity; and the target identity is an identity attribute assigned at the start of the game. The target virtual object is a virtual object determined from a plurality of second virtual objects in an alive state. The target state is a state where at least a portion of the interactions configured for the target virtual object in a second virtual scene are in a restricted state. The second virtual scene is a virtual scene displayed in the graphical user interface in response to a preset trigger event, and the second virtual scene includes at least one second virtual object or its object icon.

In this embodiment, the description is made from the perspective of a first virtual object with a target identity. A first virtual scene is first provided in the graphical user interface, as shown in FIG. 8, in which the virtual object can move, or perform a game task, or perform other interactive operations. The user triggers a movement operation for the first virtual object to control the movement of the first virtual object in the first virtual scene, and in most cases, the first virtual object is located in a position at a relative center of a range of the first virtual scene displayed in the graphical user interface. The virtual camera in the first virtual scene moves following the movement of the first virtual object, which in turn causes the range of the first virtual scene displayed in the graphical user interface to change correspondingly according to the movement of the first virtual object.

The virtual objects participating in the current game match are in the same first virtual scene. Therefore, during the movement of the first virtual object, if the first virtual object is closer to the other virtual objects, there may be other virtual objects entering into the range of the first virtual scene displayed in the graphical user interface, which are characters controlled by the other players. As shown in FIG. 8, there are two nearby second virtual objects displayed in the range of the first virtual scene, in addition to which there is displayed in the graphical user interface a movement control for controlling the movement of the first virtual object, a plurality of attack controls, and a discussion control. The discussion control may be configured to control the virtual objects to enter the second virtual scene.

The temporary virtual object is a virtual object controlled by the first virtual object with a target identity, and the target identity is an identity attribute assigned at the start of the game. The target virtual object is a virtual object determined from a plurality of second virtual objects in an alive state. The target state is a state where at least a portion of the interactions configured for the target virtual object in a second virtual scene are in a restricted state. The second virtual scene is a virtual scene displayed in the graphical user interface in response to a preset trigger event, and the second virtual scene includes at least one second virtual object or its character icon.

In an initial state, the temporary virtual object is not controlled by the user, but under certain specific conditions, the first virtual object with the target identity itself or the user corresponding to the first virtual object with the target identity has the permission to control the temporary virtual object. Specifically, the temporary virtual object may be controlled to move from an initial position to a position of the target virtual object in the first virtual scene, and to perform a specified operation on the target virtual object. The initial position may be a position where the temporary virtual object is located when it is not controlled. The specified operation may be an attack operation that produces, after the specified operation is performed on the target virtual object, a specific effect on the target virtual object, i.e., the above-described “make the target virtual object to enter a target state”.

When the user controls the first virtual object to move in the first virtual scene, the user may determine the target virtual object from a plurality of second virtual objects in an alive state. The plurality of second virtual objects in the alive state may refer to the virtual objects in the alive state other than the first virtual object in the current game match. Specifically; the user may determine the target virtual object based on the position, behavior, etc. of each of the second virtual objects. For example, the user selects a virtual object as the target virtual object that is relatively isolated and is not easily detected by other virtual objects when attacking. After the target virtual object is determined, it may be controlled to move in the first virtual scene to the position of the target virtual object from an initial position, and a specified operation may be performed on the target virtual object, and then the target virtual object enters a target state.

The second virtual scene is displayed in the graphical user interface upon the triggering of the preset trigger event. For example, the trigger event may be a specific trigger operation, which may be performed by any virtual object in the alive state. For example, in FIG. 5, the second virtual scene may be displayed in the graphical user interface by triggering the discussion control, thereby realizing that the virtual scene is switched from the first virtual scene to the second virtual scene, and all virtual objects in the current game match are moved from the first virtual scene to the second virtual scene. The second virtual scene includes at least one second virtual object or its object icon in addition to the first virtual object or an object icon of the first virtual object, where the object icon may be an avatar, a name, etc., of the virtual object.

In the second virtual scene, the virtual object in the alive state has the permission to speak, discuss and vote, but the target virtual object enters the target state, resulting in at least some of the interactions configured for the target virtual object in the second virtual scene being in a restricted state. The interactions may include speaking, discussing and voting interactions, etc. The restricted state may be that a certain interaction is not allowed, or a certain interaction is not allowed within a certain period of time, or a certain interaction is limited to a specified number of times.

As shown in FIG. 9, the second virtual scene includes a plurality of virtual objects in the alive state, including the first virtual object. The first virtual object may send a discussion message through a “Click to Input” control and a “Speech Translation” control on the right side. The discussion message sent by the virtual object may be displayed on a discussion message panel, and the discussion message may include who initiates the discussion, who is attacked, the position of the virtual object that is attacked, and the position of each virtual object upon the initiation of the discussion, etc.

The user may vote for a virtual object by clicking on the virtual object in the second virtual scene to display a voting button for the virtual object in the vicinity of the virtual object. The user may also click on an abstain button to give up the voting right for this time.

In the above target attack method in the game, in the first virtual scene, the first virtual object with the target identity can control the temporary virtual object to perform the specified operation on the target virtual object, without controlling the first virtual object to directly perform the specified operation on the target virtual object, and the attack method is easy to operate, which can help the first virtual object to reduce the risk of exposing the target identity; and to improve the success rate of the attack.

Function Six. This embodiment provides an interactive data processing function in a game. In response to a touch operation for a movement control area, a first virtual object is controlled to move in a virtual scene, and a range of the virtual scene displayed in a graphical user interface is controlled to change according to the movement of the first virtual object. It is determined that the first virtual object moves to a responsive area of a target virtual entity in the virtual scene, and the target virtual entity is provided in the virtual scene to be interacted with the virtual object. In response to a control instruction triggered by the touch operation, a display state of the first virtual object is controlled to switch to an invisible state and a marker for referring to the first virtual object is displayed in an area of the target virtual entity.

The movement control area is configured to control the movement of the virtual object in the virtual scene, and the movement control area may be a virtual joystick, through which a direction of the movement of the virtual object may be controlled, and a speed of the movement of the virtual object may also be controlled.

The virtual scene displayed in the graphical user interface is mainly obtained by taking images of a virtual scene range corresponding to the position of the virtual object through the virtual camera. During the movement of the virtual object, the virtual camera may usually be configured to follow the movement of the virtual object, in which case the range of the virtual scene taken by the virtual camera will also follow the movement.

Some virtual entities with interaction functions may be provided in the virtual scene, and the virtual entities may interact with the virtual objects. The interaction may be triggered when the virtual object is located in the responsive area of the virtual entity. At least one virtual entity having an interaction function may be included in the virtual scene, and the target virtual entity is any one of the at least one virtual entity having an interaction function.

The range of the responsive area of the virtual entity may be set in advance, for example, the range of the responsive area may be set according to the size of the virtual entity, or the range of the responsive area may be set according to the type of the virtual entity; which may be set according to the actual requirements. For example, the range of the responsive area of the virtual entity of a vehicle type may be set to be greater than the area where the virtual entity is located, and the range of the responsive area of the virtual entity of a prop type used for pranks may be set to be equal to the area where the virtual entity is located.

The touch operation, for triggering the control instruction, may be a specific operation for a specified area or a specific operation for a specified object. For example, the control instruction may be triggered by double clicking on the target virtual entity. For another example, an interactive control may be provided in the graphical user interface, and the control instruction may be triggered by clicking on the interactive control. The interactive control may be provided after it is determined that the first virtual object moves to the responsive area of the target virtual entity in the virtual scene. Based on this, the method may further include: controlling the graphical user interface to display the interactive control of the target virtual entity, and the control instruction triggered by the touch operation includes a control instruction triggered by touching the interactive control.

This embodiment of the present disclosure can realize that after a game player triggers an interaction with a virtual object, the display state of the virtual object may be controlled to switch to an invisible state, and the switching of the display state as well as the operation for switching will not affect the process of the game by themselves, which increases the interaction with the game player, improves the interestingness, and enhances the user experience.

In some embodiments, the target virtual entity may be a virtual vehicle, and the virtual vehicle may be preset with a preset threshold value, which is configured to indicate the maximum number of bearers of the virtual vehicle, that is, the maximum number of virtual objects that are invisible on the virtual vehicle. Based on this, if it is determined that the virtual vehicle is fully loaded, a player who subsequently performs an invisible switch may be instructed that the invisibility has failed.

In some embodiments, the reasoning game may include two sessions that may be divided into two parts, an action session and a voting session. In the action session, all virtual objects in the alive state (players in the game) can act, e.g., they can do tasks, they can mess up, etc. In the voting session, players can gather to discuss and vote on the results of their reasoning, e.g., to reason about the identity of each virtual object, and the different identities of virtual objects may correspond to different tasks. In this type of game, a skill may also be released in the area of the target virtual entity to perform a task, or to cause a disturbance, and the like. Based on this, after it is determined that the first virtual object moves to the responsive area of the target virtual entity in the virtual scene, the method may further include: responding to a skill release instruction triggered by the touch operation, determining at least one virtual object that is invisible in the area of the target virtual entity as a candidate virtual object; and randomly determining one of the at least one candidate virtual object as the object on which the skill release instruction is to be acted upon.

The virtual object on which the skill release instruction triggered by the touch operation acts may be a character in the invisible state or a virtual object in the non-invisible state.

Function Seven. This embodiment provides a scene recording function in a game. A game interface is displayed on a graphical user interface, the game interface including at least part of a first virtual scene in a first game task stage, and a first virtual object located in the first virtual scene. In response to a movement operation for the first virtual object, a range of the virtual scene displayed in the game interface is controlled to change according to the movement operation. An image of a preset range of a current game interface is obtained in response to a record instruction triggered in the first game task stage. The image is stored. The image is displayed in response to a view instruction triggered in a second game task stage, and the second game task stage and the first game task stage are different task stages in a game match that the first virtual object is currently in.

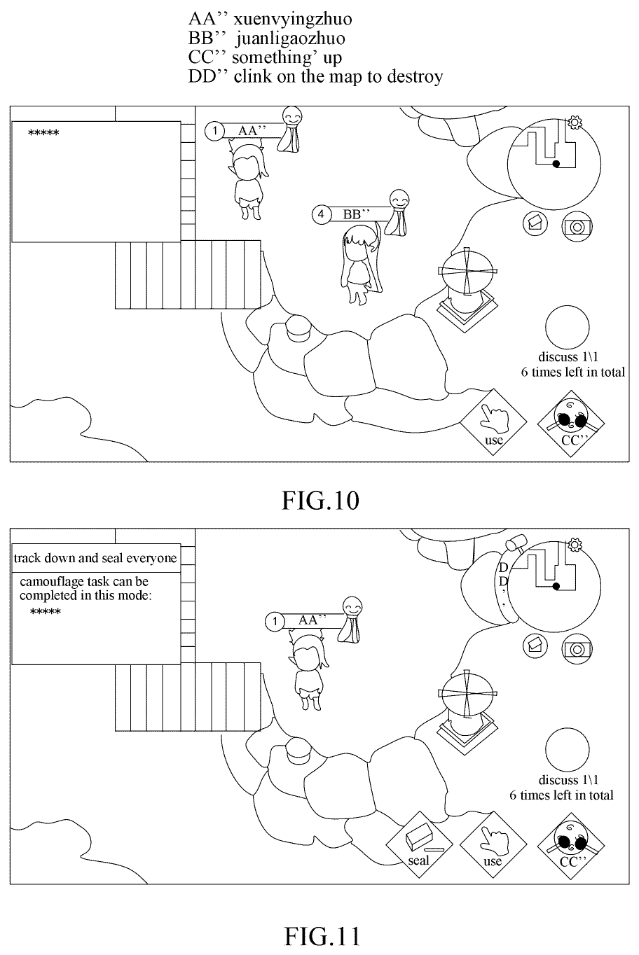

In this embodiment, the description is made from the perspective of a first virtual object with a target identity. A first virtual scene is first provided in the graphical user interface, as shown in FIGS. 10-11, in which the virtual object can move, or perform a game task, or perform other interactive operations. The user triggers a movement operation for the first virtual object to control the movement of the first virtual object in the first virtual scene, and in most cases, the first virtual object is located in a position at a relative center of a range of the first virtual scene displayed in the graphical user interface. The virtual camera in the first virtual scene moves following the movement of the first virtual object, which in turn causes the range of the first virtual scene displayed in the graphical user interface to change correspondingly according to the movement of the first virtual object.

The virtual objects participating in the current game match are in the same first virtual scene. Therefore, during the movement of the first virtual object, if the first virtual object is closer to the other virtual objects, there may be other virtual objects entering into the range of the first virtual scene displayed in the graphical user interface, which are characters controlled by the other players. As shown in FIGS. 10-11, there are two nearby second virtual objects displayed in the range of the first virtual scene, in addition to which there is displayed in the graphical user interface a movement control for controlling the movement of the first virtual object, a plurality of attack controls, and a discussion control. The discussion control may be configured to control the virtual objects to enter the second virtual scene.

When the user controls the first virtual object to move in the first virtual scene, the user may determine the target virtual object from a plurality of second virtual objects in an alive state. The plurality of second virtual objects in the alive state may refer to the virtual objects in the alive state other than the first virtual object in the current game match. Specifically, the user may determine the target virtual object based on the position, behavior, etc. of each of the second virtual objects. For example, the user selects a virtual object as the target virtual object that is relatively isolated and is not easily detected by other virtual objects when attacking. After the target virtual object is determined, it may be controlled to move in the first virtual scene to the position of the target virtual object from an initial position, and a specified operation may be performed on the target virtual object, and then the target virtual object enters a target state.

The second virtual scene is displayed in the graphical user interface upon the triggering of the preset trigger event. For example, the trigger event may be a specific trigger operation, which may be performed by any virtual object in the alive state. For example, as shown in FIGS. 10-11, the second virtual scene may be displayed in the graphical user interface by triggering the discussion control, thereby realizing that the virtual scene is switched from the first virtual scene to the second virtual scene, and all virtual objects in the current game match are moved from the first virtual scene to the second virtual scene. The second virtual scene includes at least one second virtual object or its object icon in addition to the first virtual object or an object icon of the first virtual object, where the object icon may be an avatar, a name, etc., of the virtual object.

In the second virtual scene, the virtual object in the alive state has the permission to speak, discuss and vote, but the target virtual object enters the target state, resulting in at least some of the interactions configured for the target virtual object in the second virtual scene being in a restricted state. The interactions may include speaking, discussing and voting interactions, etc. The restricted state may be that a certain interaction is not allowed, or a certain interaction is not allowed within a certain period of time, or a certain interaction is limited to a specified number of times.

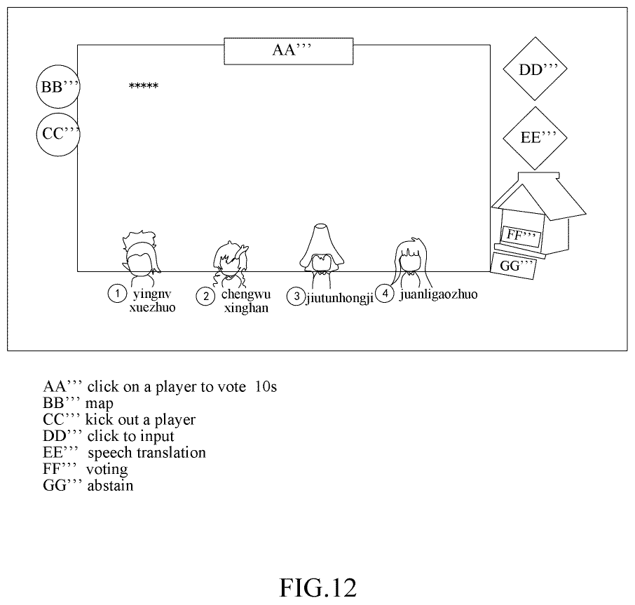

As shown in FIG. 12, the second virtual scene includes a plurality of virtual objects in the alive state, including the first virtual object. The first virtual object may send a discussion message through a “Click to Input” control and a “Speech Translation” control on the right side. The discussion message sent by the virtual object may be displayed on a discussion message panel, and the discussion message may include who initiates the discussion, who is attacked, the position of the virtual object that is attacked, and the position of each virtual object upon the initiation of the discussion, etc.

The user may vote for a virtual object by clicking on the virtual object in the second virtual scene to display a voting button for the virtual object in the vicinity of the virtual object. The user may also click on an abstain button to give up the voting right for this time.

In response to a touch operation for a function control, a position marking interface is displayed in the graphical user interface, and in the position marking interface, a character identifier of the at least one second virtual object and/or the first virtual object is displayed based on the position marking information reported by the at least one second virtual object and/or the first virtual object.

Function Eight. This embodiment provides a game operation function. A graphical user interface is provided via a terminal, the graphical user interface includes a virtual scene and a virtual object, the virtual scene includes a plurality of transport areas, and the plurality of transport areas include a first transport area and at least one second transport area at a different position in the scene corresponding to the first transport area. In response to a touch operation directed to a movement control area, the virtual object is controlled to move in the virtual scene. It is determined that the virtual object moves to the first transport area, and a first set of directional controls, corresponding to the at least one second transport area, is displayed in the movement control area. In response to a trigger instruction directed to a target directional control among the first set of directional controls, the virtual scene displayed in the graphical user interface that includes the first transport area is controlled to change to a virtual scene that includes the second transport area corresponding to the target directional control.

In response to a touch operation directed to a movement control area, the virtual object is controlled to move in the virtual scene. It is determined that the virtual object moves to the first transport area, and a first set of directional controls, corresponding to the at least one second transport area, is displayed in the movement control area. In response to a trigger instruction directed to a target directional control among the first set of directional controls, the range of the virtual scene displayed in the graphical user interface that includes the first transport area is controlled to change to a range of a virtual scene that includes the second transport area corresponding to the target directional control.

In this embodiment, the graphical user interface includes at least a portion of a virtual scene and a virtual object. The virtual scene includes a plurality of transport areas, and the plurality of transport areas include a first transport area and at least one second transport area at a different position in the scene corresponding to the first transport area. The first transport area may be an entrance area of a hidden area (e.g., a tunnel, a subway, etc., the tunnel being used as an example in the present disclosure). The second transport area may be an exit area of the hidden area.

The graphical user interface may include a movement control area, and the position of the movement control area in the graphical user interface may be customized based on actual requirements, for example, it may be set in the lower left, lower right, and other thumb-touchable areas of the graphical user interface for the game player.

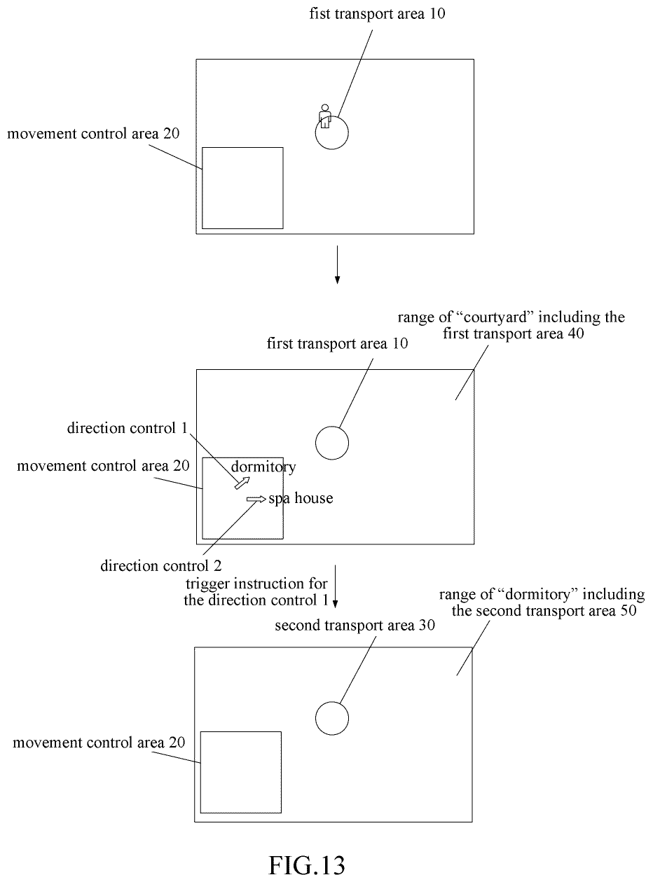

As shown in FIG. 13, a user inputs a touch operation directed to a movement control area to control movement of a virtual object in a virtual scene, and if it is determined that the virtual object moves to a first transport area, a first set of directional controls (directional control 1 and directional control 2) corresponding to at least one second transport area is displayed in the movement control area. The first set of directional controls is configured to indicate the direction of the corresponding tunnel exit.

The user inputs a trigger instruction for the target directional control (directional control 1) of the first set of directional controls to change a range of the virtual scene displayed in the graphical user interface that includes the first transport area to a range of the virtual scene that includes the second transport area corresponding to the target directional control. That is, through the trigger instruction for the target directional control, the current display in the graphical user interface is made to be the range of the virtual scene of the second transport area corresponding to the directional control 1. The specific implementation of the process may be referred to in the above embodiments.

Based on the same inventive concept, embodiments of the present disclosure further provide an apparatus for displaying information of a virtual object corresponding to the method for displaying the information of the virtual object. Since the problem-solving principle of the apparatus in embodiments of the present disclosure is similar to the method for displaying the information of the virtual object described above in embodiments of the present disclosure, for implementations of the apparatus, reference may be made to the implementations of the method, and repeated details will not be given again.

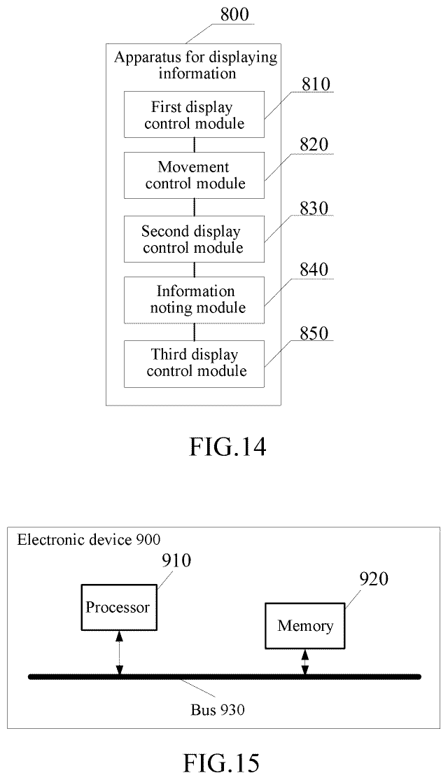

Reference is made to FIG. 14, which is a schematic structural diagram of an apparatus for displaying information of a virtual object provided by an embodiment of the present disclosure. As shown in FIG. 14, a graphical user interface is provided by a terminal device, and the apparatus 800 for displaying the information of the virtual object includes:
a first display control module 810, configured to display in the graphical user interface a first virtual scene and a first virtual object located in the first virtual scene;
a movement control module 820, configured to, in response to a movement operation for the first virtual object, control the first virtual object to move in the first virtual scene, and control, according to movement of the first virtual object, a first virtual scene range displayed in the graphical user interface to change accordingly;
a second display control module 830, configured to display in the graphical user interface note prompt information of at least one second virtual object in response to a note addition operation;
an information noting module 840, configured to add note information to a target virtual object among the at least one second virtual object displayed in response to a trigger operation for the note prompt information; and
a third display control module 850, configured to, if the target virtual object and the first virtual object are teammates and attribute information of the target virtual object is known, display the added note information and the known attribute information around the target virtual object.

In embodiments of the present disclosure, the note information is added to the virtual object of the other player in the game, so that it is easy for the player to record the identity information of the other player that has been inferred during the game, and the note addition operation is relatively convenient, which can prevent the player from forgetting the identity information corresponding to the other player that has been inferred. In addition, a player with a suspicious identity is determined based on the identity information of the player that has been inferred, so that the player can avoid the player with the suspicious identity when taking action. In this way, the gaming efficiency of the player can be improved.

Reference is made to FIG. 15, which is a schematic structural diagram of an electronic device provided by an embodiment of the present disclosure. As shown in FIG. 15, the electronic device 900 includes a processor 910, a memory 920 and a bus 930.

The memory 920 stores machine-readable instructions executable by the processor 910. When the electronic device 900 is running, the processor 910 is in communication with the memory 920 through the bus 930. The machine-readable instructions, when executed by the processor 910, may execute the method steps:
displaying in the graphical user interface a first virtual scene and a first virtual object located in the first virtual scene;
in response to a movement operation for the first virtual object, controlling the first virtual object to move in the first virtual scene, and controlling, according to movement of the first virtual object, a first virtual scene range displayed in the graphical user interface to change accordingly;
displaying in the graphical user interface note prompt information of at least one second virtual object in response to a note addition operation; and
adding note information to a target virtual object among the at least one second virtual object displayed in response to a trigger operation for the note prompt information.

In some embodiments of the present disclosure, the step of displaying in the graphical user interface the note prompt information of the at least one second virtual object in response to the note addition operation includes:
in response to the note addition operation, displaying a note list in the graphical user interface, and displaying in the note list the note prompt information of the at least one second virtual object.

In some embodiments of the present disclosure, the method further includes:
displaying in the note list note prompt information of at least one third virtual object, wherein the at least one second virtual object is a virtual object in an alive state, and the at least one third virtual object is a virtual object in a dead state.

In some embodiments of the present disclosure, the step of displaying in the note list the note prompt information of the at least one second virtual object includes:
displaying in the note list the note prompt information of the at least one second virtual object according to a display priority of second virtual object, wherein the display priority is determined according to a distance between the at least one second virtual object and the first virtual object.

In some embodiments of the present disclosure, the step of displaying in the note list the note prompt information of the at least one second virtual object includes:
displaying in the note list the at least one second virtual object and a note control, and displaying in the note control the note prompt information of the at least one second virtual object.

In some embodiments of the present disclosure, the method may further include:
in response to a preset trigger event, displaying a second virtual scene in the graphical user interface, wherein the second virtual scene includes the at least one second virtual object; and visually marking the second virtual object according to the note prompt information.

In some embodiments of the present disclosure, the note prompt information includes a plurality pieces of identity information configured to indicate an identity of a virtual object, and the note information includes an identity identifier; and
wherein the step of adding the note information to the target virtual object among the at least one second virtual object displayed in response to the trigger operation for the note prompt information includes:
in response to a selection operation for target identity information, displaying an identity identifier corresponding to the selected target identity information at a preset position corresponding to the target virtual object.

In some embodiments of the present disclosure, the method further includes:
when displaying the second virtual scene in the graphical user interface, displaying an identity voting control of the at least one second virtual object in the graphical user interface; and
in response to a voting operation for the identity voting control, performing a corresponding voting instruction.

In some embodiments of the present disclosure, the second virtual scene includes a plurality of virtual objects, and the plurality of virtual objects include the first virtual object, the at least one second virtual object, and/or at least one third virtual object, wherein the at least one second virtual object is a virtual object in an alive state, and the at least one third virtual object is a virtual object in a dead state, and wherein the method further includes:
in response to the note addition operation, displaying in the graphic user interface note prompt information of the at least one second virtual object and/or the at least one third virtual object; and
in response to the trigger operation for the note prompt information, adding note information to a target virtual object among the at least one second virtual object and/or the at least one third virtual object displayed.

In some embodiments of the present disclosure, the at least one second virtual object is a plurality of second virtual objects, and the step of displaying in the graphical user interface the note prompt information of the at least one second virtual object in response to the note addition operation includes:
in response to a multi-selection operation for the plurality of second virtual objects, displaying the note prompt information around any of the plurality of second virtual objects.

In some embodiments of the present disclosure, the step of displaying in the graphical user interface the note prompt information of the at least one second virtual object in response to the note addition operation includes:
in response to the note addition operation, generating a note control and a screenshot image corresponding to the current graphical user interface, the screenshot image including the at least one second virtual object, and displaying in the note control the note prompt information of the at least one second virtual object.

In some embodiments of the present disclosure, the step of adding the note information to the target virtual object among the at least one second virtual object displayed in response to the trigger operation for the note prompt information includes:
in response to a drag operation for the note control, dragging the note control to a position where the target virtual object is located, to add the note prompt information corresponding to the dragged note control to the target virtual object.

In some embodiments of the present disclosure, the method further includes:
storing the screenshot image including the target virtual object with the added note information, and recording a note time; and
in response to a note viewing operation, displaying in the graphical user interface the stored screenshot image according to the note time.

In some embodiments of the present disclosure, the method further includes:
displaying the added note information around the target virtual object.

In some embodiments of the present disclosure, the step of displaying the added note information around the target virtual object includes:
if the target virtual object and the first virtual object are teammates and attribute information of the target virtual object is known, displaying the added note information and the known attribute information around the target virtual object.

For specific implementations of embodiments of the present disclosure, reference may be made to the method embodiments, which will not be described again here.
Embodiments of the present disclosure further provide a computer-readable storage medium having a computer program stored thereon, which, when run by a processor, may execute the method steps:
displaying in the graphical user interface a first virtual scene and a first virtual object located in the first virtual scene;
in response to a movement operation for the first virtual object, controlling the first virtual object to move in the first virtual scene, and controlling, according to movement of the first virtual object, a first virtual scene range displayed in the graphical user interface to change accordingly;
displaying in the graphical user interface note prompt information of at least one second virtual object in response to a note addition operation; and
adding note information to a target virtual object among the at least one second virtual object displayed in response to a trigger operation for the note prompt information.

In some embodiments of the present disclosure, the step of displaying in the graphical user interface the note prompt information of the at least one second virtual object in response to the note addition operation includes:
in response to the note addition operation, displaying a note list in the graphical user interface, and displaying in the note list the note prompt information of the at least one second virtual object.

In some embodiments of the present disclosure, the method further includes:
displaying in the note list note prompt information of at least one third virtual object, wherein the at least one second virtual object is a virtual object in an alive state, and the at least one third virtual object is a virtual object in a dead state.

In some embodiments of the present disclosure, the step of displaying in the note list the note prompt information of the at least one second virtual object includes:
displaying in the note list the note prompt information of the at least one second virtual object according to a display priority of second virtual object, wherein the display priority is determined according to a distance between the at least one second virtual object and the first virtual object.

In some embodiments of the present disclosure, the step of displaying in the note list the note prompt information of the at least one second virtual object includes:
displaying in the note list the at least one second virtual object and a note control, and displaying in the note control the note prompt information of the at least one second virtual object.

In some embodiments of the present disclosure, the method may further include:
in response to a preset trigger event, displaying a second virtual scene in the graphical user interface, wherein the second virtual scene includes the at least one second virtual object; and visually marking the second virtual object according to the note prompt information.

In some embodiments of the present disclosure, the note prompt information includes a plurality pieces of identity information configured to indicate an identity of a virtual object, and the note information includes an identity identifier; and
wherein the step of adding the note information to the target virtual object among the at least one second virtual object displayed in response to the trigger operation for the note prompt information includes:
in response to a selection operation for target identity information, displaying an identity identifier corresponding to the selected target identity information at a preset position corresponding to the target virtual object.

In some embodiments of the present disclosure, the method further includes:
when displaying the second virtual scene in the graphical user interface, displaying an identity voting control of the at least one second virtual object in the graphical user interface; and
in response to a voting operation for the identity voting control, performing a corresponding voting instruction.

In some embodiments of the present disclosure, the second virtual scene includes a plurality of virtual objects, and the plurality of virtual objects include the first virtual object, the at least one second virtual object, and/or at least one third virtual object, wherein the at least one second virtual object is a virtual object in an alive state, and the at least one third virtual object is a virtual object in a dead state, and wherein the method further includes:
in response to the note addition operation, displaying in the graphic user interface note prompt information of the at least one second virtual object and/or the at least one third virtual object; and
in response to the trigger operation for the note prompt information, adding note information to a target virtual object among the at least one second virtual object and/or the at least one third virtual object displayed.

In some embodiments of the present disclosure, the at least one second virtual object is a plurality of second virtual objects, and the step of displaying in the graphical user interface the note prompt information of the at least one second virtual object in response to the note addition operation includes:
in response to a multi-selection operation for the plurality of second virtual objects, displaying the note prompt information around any of the plurality of second virtual objects.

In some embodiments of the present disclosure, the step of displaying in the graphical user interface the note prompt information of the at least one second virtual object in response to the note addition operation includes:
in response to the note addition operation, generating a note control and a screenshot image corresponding to the current graphical user interface, the screenshot image including the at least one second virtual object, and displaying in the note control the note prompt information of the at least one second virtual object.

In some embodiments of the present disclosure, the step of adding the note information to the target virtual object among the at least one second virtual object displayed in response to the trigger operation for the note prompt information includes:
in response to a drag operation for the note control, dragging the note control to a position where the target virtual object is located, to add the note prompt information corresponding to the dragged note control to the target virtual object.

In some embodiments of the present disclosure, the method further includes:
storing the screenshot image including the target virtual object with the added note information, and recording a note time; and
in response to a note viewing operation, displaying in the graphical user interface the stored screenshot image according to the note time.

In some embodiments of the present disclosure, the method further includes:
displaying the added note information around the target virtual object.

In some embodiments of the present disclosure, the step of displaying the added note information around the target virtual object includes:
if the target virtual object and the first virtual object are teammates and attribute information of the target virtual object is known, displaying the added note information and the known attribute information around the target virtual object.

For specific implementations of embodiments of the present disclosure, reference may be made to the method embodiments, which will not be described again here.

Those skilled in the art can clearly understand that for the convenience and simplicity of description, for specific working processes of the systems, apparatuses and units described above, reference may be made to corresponding processes in the foregoing method embodiments, which will not be described again here.

It should be understood in the several embodiments provided in the present disclosure that the systems, apparatuses and methods disclosed, may be implemented in other ways. For example, the device embodiments described above are merely schematic. The division of the units described is only a logical functional division, and in the actual implementation, there may be other ways of division, such as multiple units or components may be combined or may be integrated into another system, or some features may be ignored, or not implemented. On the other hand, the coupling or direct coupling or communication connection between each other shown or discussed may be a connection through some communication interface, and the indirect coupling or communication connection of devices or units, may be electrical, mechanical or other forms.

The units illustrated as separated components may or may not be physically separated, and the components shown as units may or may not be physical units, i.e., they may be located in a single place, or they may be distributed to a plurality of network units. Some or all of these units may be selected to fulfill the purpose of the solution of embodiments according to actual requirements.

In addition, the respective functional units in various embodiments of the present disclosure may be integrated in a single processing unit, or each unit may physically exist separately, or two or more units may be integrated in a single unit.

When the functions are implemented in a form of a software functional unit and sold or used as an independent product, the functions may be stored in a non-volatile computer-readable storage medium that is executable by a processor. Based on such an understanding, the technical solutions of the present disclosure essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in embodiments of the present disclosure. The foregoing storage medium includes various media that can store program codes, such as a USB flash drive, a removable hard disk, a read-only memory (ROM), a random access memory (RAM), a magnetic disk, and an optical disc.

Finally, it should be noted that the foregoing embodiments are merely specific implementations of the present disclosure, and are intended for describing the technical solutions in the present disclosure but not for limiting the present disclosure. The protection scope of the present disclosure is not limited thereto. Although the present disclosure is described in detail with reference to the foregoing embodiments, persons of ordinary skill in the art should understand that they may still make modifications to the technical solutions described in the foregoing embodiments, or readily FIG. out variations, or make equivalent replacements to some technical features thereof, within the technical scope disclosed in the present disclosure. However, these modifications, variations, or replacements do not make the essence of the corresponding technical solutions depart from the spirit and scope of the technical solutions in embodiments of the present disclosure, and therefore shall fall within the protection scope of the present disclosure. Therefore, the protection scope of the present disclosure shall be subject to the protection scope of the appended claims.

1. A method for displaying information of a virtual object, wherein a graphical user interface is provided by a terminal device, and wherein the method comprises:
displaying in the graphical user interface a first virtual scene and a first virtual object located in the first virtual scene;
in response to a movement operation for the first virtual object, controlling the first virtual object to move in the first virtual scene, and controlling, according to movement of the first virtual object, a first virtual scene range displayed in the graphical user interface to change accordingly;
displaying in the graphical user interface note prompt information of at least one second virtual object in response to a note addition operation; and
adding note information to a target virtual object among the at least one second virtual object displayed in response to a trigger operation for the note prompt information.

2. The method according to claim 1, wherein the step of displaying in the graphical user interface the note prompt information of the at least one second virtual object in response to the note addition operation comprises:
in response to the note addition operation, displaying a note list in the graphical user interface, and displaying in the note list the note prompt information of the at least one second virtual object.

3. The method according to claim 2, further comprising:
displaying in the note list note prompt information of at least one third virtual object, wherein the at least one second virtual object is a virtual object in an alive state, and the at least one third virtual object is a virtual object in a dead state.

4. The method according to claim 2, wherein the step of displaying in the note list the note prompt information of the at least one second virtual object comprises:
displaying in the note list the note prompt information of the at least one second virtual object according to a display priority of second virtual object, wherein the display priority is determined according to a distance between the at least one second virtual object and the first virtual object.

5. The method according to claim 2, wherein the step of displaying in the note list the note prompt information of the at least one second virtual object comprises:
displaying in the note list the at least one second virtual object and a note control, and displaying in the note control the note prompt information of the at least one second virtual object.

6. The method according to claim 1, further comprising:
in response to a preset trigger event, displaying a second virtual scene in the graphical user interface, wherein the second virtual scene comprises the at least one second virtual object; and
visually marking the at least one second virtual object according to the note prompt information.

7. The method according to claim 6, wherein the note prompt information comprises a plurality pieces of identity information configured to indicate an identity of a virtual object, and the note information comprises an identity identifier; and
wherein the step of adding the note information to the target virtual object among the at least one second virtual object displayed in response to the trigger operation for the note prompt information comprises:
in response to a selection operation for target identity information, displaying an identity identifier corresponding to the selected target identity information at a preset position corresponding to the target virtual object.

8. The method according to claim 7, further comprising:
when displaying the second virtual scene in the graphical user interface, displaying an identity voting control of the at least one second virtual object in the graphical user interface; and
in response to a voting operation for the identity voting control, performing a voting instruction.

9. The method according to claim 8, wherein the second virtual scene comprises a plurality of virtual objects, and the plurality of virtual objects comprise the first virtual object, the at least one second virtual object, and/or at least one third virtual object, wherein the at least one second virtual object is a virtual object in an alive state, and the at least one third virtual object is a virtual object in a dead state, and wherein the method further comprises:
in response to the note addition operation, displaying in the graphic user interface note prompt information of the at least one second virtual object and/or the at least one third virtual object; and
in response to the trigger operation for the note prompt information, adding note information to a target virtual object among the at least one second virtual object and/or the at least one third virtual object displayed.

10. The method according to claim 6, wherein the at least one second virtual object is a plurality of second virtual objects, and the step of displaying in the graphical user interface the note prompt information of the at least one second virtual object in response to the note addition operation comprises:
in response to a multi-selection operation for the plurality of second virtual objects, displaying the note prompt information around any of the plurality of second virtual objects.

11. The method according to claim 1, wherein the step of displaying in the graphical user interface the note prompt information of the at least one second virtual object in response to the note addition operation comprises:
in response to the note addition operation, generating a note control and a screenshot image corresponding to the graphical user interface, the screenshot image comprising the at least one second virtual object, and displaying in the note control the note prompt information of the at least one second virtual object.

12. The method according to claim 11, wherein the step of adding the note information to the target virtual object among the at least one second virtual object displayed in response to the trigger operation for the note prompt information comprises:
in response to a drag operation for the note control, dragging the note control to a position where the target virtual object is located, to add the note prompt information corresponding to the dragged note control to the target virtual object.

13. The method according to claim 12, further comprising:
storing the screenshot image comprising the target virtual object with the added note information, and recording a note time; and
in response to a note viewing operation, displaying in the graphical user interface the stored screenshot image according to the note time.

14. The method according to claim 1, further comprising:
displaying the added note information around the target virtual object.

15. The method according to claim 14, wherein the step of displaying the added note information around the target virtual object comprises:
if the target virtual object and the first virtual object are teammates and attribute information of the target virtual object is known, displaying the added note information and the known attribute information around the target virtual object.

16. (canceled)

17. An electronic device, comprising: a processor, a storage medium and a bus, wherein a graphical user interface is provided by the electronic device, and wherein machine-readable instructions executable by the processor are stored in the storage medium, and when the electronic device is running, the processor is in communication with the storage medium through the bus, and the processor is configured to:
display in the graphical user interface a first virtual scene and a first virtual object located in the first virtual scene;
in response to a movement operation for the first virtual object, control the first virtual object to move in the first virtual scene, and control, according to movement of the first virtual object, a first virtual scene range displayed in the graphical user interface to change accordingly;
display in the graphical user interface note prompt information of at least one second virtual object in response to a note addition operation; and
add note information to a target virtual object among the at least one second virtual object displayed in response to a trigger operation for the note prompt information.

18. A non-transitory computer-readable storage medium having a computer program stored thereon, wherein a graphical user interface is provided by a terminal device, and the computer program, when run by a processor, executes the following operations:
displaying in the graphical user interface a first virtual scene and a first virtual object located in the first virtual scene;
in response to a movement operation for the first virtual object, controlling the first virtual object to move in the first virtual scene, and controlling, according to movement of the first virtual object, a first virtual scene range displayed in the graphical user interface to change accordingly;
displaying in the graphical user interface note prompt information of at least one second virtual object in response to a note addition operation; and
adding note information to a target virtual object among the at least one second virtual object displayed in response to a trigger operation for the note prompt information.

19. The electronic device according to claim 17, wherein the processor is further configured to:
in response to the note addition operation, display a note list in the graphical user interface, and display in the note list the note prompt information of the at least one second virtual object.

20. The electronic device according to claim 19, wherein the processor is further configured to:
display in the note list note prompt information of at least one third virtual object, wherein the at least one second virtual object is a virtual object in an alive state, and the at least one third virtual object is a virtual object in a dead state.

21. The electronic device according to claim 19, wherein the processor is further configured to:
display in the note list the note prompt information of the at least one second virtual object according to a display priority of second virtual object, wherein the display priority is determined according to a distance between the at least one second virtual object and the first virtual object.
